(19) United States
(12) Patent Application Publication
(10) Pub. No.: US 2012/0169482 A1
(43) Pub. Date: Jul. 5, 2012

(54) System and Method for Selecting a Device for Remote Control Based on Determined Navigational State of a Remote Control Device

(76) Inventors: Ian Chen, Campbell, CA (US); James V. Steele, Los Gatos, CA (US)

(21) Appl. No.: 13/343,654

(22) Filed: Jan. 4, 2012

Related U.S. Application Data
(60) Provisional application No. 61/430,106, filed on Jan. 5, 2011.

(51) Int. Cl. G05B 11/01

(52) U.S. Cl. 340/12.52

(57) ABSTRACT

A computer system having one or more processors and memory receives data corresponding to a device-selection command performed at a remote control, where the remote control is configured to provide remote-control commands to a plurality of devices. In response to receiving the data corresponding to the device-selection command, the computer system selects one of the devices as a selected device in accordance with information indicating that the remote control was pointed at a proxy for the selected device at the time that the device-selection command was performed at the remote control, where the proxy for the selected device is at a different location than the selected device. The computer system also generates a respective remote-control command for the selected device, where the respective remote-control command will, when received by the selected device, cause the selected device to perform a predefined operation that corresponds to the respective remote-control command.

### RELATED APPLICATIONS

This application claims priority to U.S. Provisional Application Ser. No. 61/430,106, filed Jan. 5, 2011, which application is incorporated by reference herein in its entirety.

This application is related to U.S. patent application Ser. No. 12/338,996, filed Dec. 18, 2008, entitled “Host System and Method for Determining an Attitude of a Device Undergoing Dynamic Acceleration,” which application is incorporated by reference herein in its entirety.

### TECHNICAL FIELD

The disclosed embodiments relate generally to remotely controlling devices, and more specifically selecting a device to be remotely controlled in response to input from a remote control in accordance with a navigational state of the remote control.

### BACKGROUND

A remote control (e.g., a human interface device for remotely controlling other devices) may be used to interact with and control a device remotely. In some circumstances a single remote control is able to remotely control multiple different devices. However, enabling a remote control to control multiple devices creates the possibility that when a user attempts to control a first device, a second device will be inadvertently controlled by the remote control. For example, a remote control that uses infrared light pulses to control two televisions may adjust the volume of both of the televisions when a user attempts to adjust the volume of one of the televisions. This is frustrating for users and requires users to spend additional time, and often additional money, to correct the problem. One conventional method of addressing this problem is to have devices with different remote control input schemes. However, this method results in each device needing a separate remote control. Another conventional method of addressing this problem is to reduce the operating range of remote controls for devices. However, this method reduces the utility of the remote control, as the user can only use the remote control in the operating range. Moreover, these problems with conventional remote controls only become more severe as the number of devices that can be remotely controlled increases. Accordingly, as the number of remotely controlled devices increases, it would be highly desirable to find an intuitive and efficient method for selecting devices for remote control by a single remote control.

### SUMMARY

Accordingly, the embodiments disclosed herein provide a method, system and computer readable storage medium for selecting a device for remote control that reduces or eliminates the problems with conventional methods of selecting a device for remote control. In particular, the disclosed embodiments describe an intuitive and efficient method, system and computer readable storage medium for selecting a device for remote control based on a determined navigational state of a remote control.

Some embodiments provide a method for remotely controlling a device, the method including, at a computer system including one or more processors and memory storing one or more programs: receiving data corresponding to a device-selection command performed at a remote control, where the remote control is configured to provide remote-control commands to a plurality of devices. The method further includes, in response to receiving the data corresponding to the device-selection command: selecting one of the devices as a selected device in accordance with a navigational state of the remote control relative to the selected device, or relative to a proxy for the selected device, at the time that the device-selection command was performed at the remote control; and generating a respective remote-control command for the selected device, where the respective remote-control command will, when received by the selected device, cause the selected device to perform a predefined operation that corresponds to the respective remote-control command.

In accordance with some embodiments, the computer system is the remote control. In accordance with some embodiments, the computer system is a controller that is in communication with the plurality of devices. In accordance with some embodiments, the remote control is a multifunction device with a remote control application. In accordance with some embodiments, the remote control is a dedicated remote control device. In some embodiments, the method further includes preparing, for display at the remote control, information identifying the selected device.

In accordance with some embodiments, the method also includes identifying multiple candidate devices from the plurality of devices in accordance with the navigational state and selecting a respective candidate device from the multiple devices as the selected device. In some embodiments, the multiple candidate devices are selected in accordance with historical navigational states of the remote control. In some embodiments, the respective candidate device is automatically selected using predefined criteria. In some embodiments, the respective candidate device is selected in accordance with additional input from a user of the remote control. In some embodiments, the method further includes, prior to selecting the respective candidate device generating a list including two or more of the multiple candidate devices and receiving a response indicating selection of the respective candidate device from the list.

In some embodiments, the method also includes receiving data corresponding to a plurality of device-selection commands for a single device where the plurality of device-selection commands were performed at a plurality of distinct remote controls, and generating the remote-control command in accordance with predefined criteria. In some embodiments, the selected device has a predefined device class; the respective remote-control command is a broadcast command that is broadcast to two or more of the plurality of devices; and the respective remote-control command will, when received by a respective additional device that has the predefined device class, cause the respective additional device to perform the predefined operation. In some embodiments, the selected device has a predefined device class, and the method further includes, after selecting the selected device: identifying one or more additional devices that have the predefined device class; and generating one or more additional remote-control commands, where a respective additional remote-control command will, when received by a respective additional device, cause the respective additional device to perform the predefined operation.

In some embodiments, the method further includes acquiring one or more sensor inputs that correspond to beacon data for one or more beacons on the remote control and calculating the navigational state of the remote control, in accordance with the acquired sensor inputs, as the remote control is moved by a user. In some of these embodiments, calculating the navigational state of the remote control includes calculating an attitude and a position of the remote control. In some embodiments, the method also includes acquiring one or more sensor inputs from sensors on the remote control and calculating the navigational state of the remote control, in accordance with the acquired sensor inputs, as the remote control is moved by a user. In some of these embodiments, calculating the navigational state of the remote control includes calculating an attitude and a position of the remote control. In some embodiments, the attitude of the remote control is calculated using a Kalman filter.

In some embodiments, a computer system (e.g., a remote control or a central controller system) includes one or more processors, memory, and one or more programs; the one or more programs are stored in the memory and configured to be executed by the one or more processors and the one or more programs include instructions for performing the operations of any of the methods described above or elsewhere in this document. In accordance with some embodiments, a non-transitory computer readable storage medium (e.g., for use by a remote control or a central controller system) has stored therein instructions which when executed by one or more processors, cause a computer system (e.g., a remote control or a central controller system) to perform the operations of any of the methods described above or elsewhere in this document.

### BRIEF DESCRIPTION OF THE DRAWINGS

FIGS. 1A-1B illustrate a system for remotely controlling devices, according to some embodiments.

FIG. 2 is a block diagram illustrating an exemplary remote control, according to some embodiments.

FIGS. 3A-3C are block diagrams illustrating configurations of various components of the system for remotely controlling devices, according to some embodiments.

FIGS. 4A-4E are flow diagrams of a method for remotely controlling devices, according to some embodiments.

FIG. 5 presents a block diagram of an exemplary remote control, according to some embodiments.

FIG. 6 presents a block diagram of an exemplary central controller system, according to some embodiments.

FIG. 7 presents a block diagram of an exemplary device to be remotely controlled, according to some embodiments.

Like reference numerals refer to corresponding parts throughout the drawings.

### DESCRIPTION OF EMBODIMENTS

### System Overview

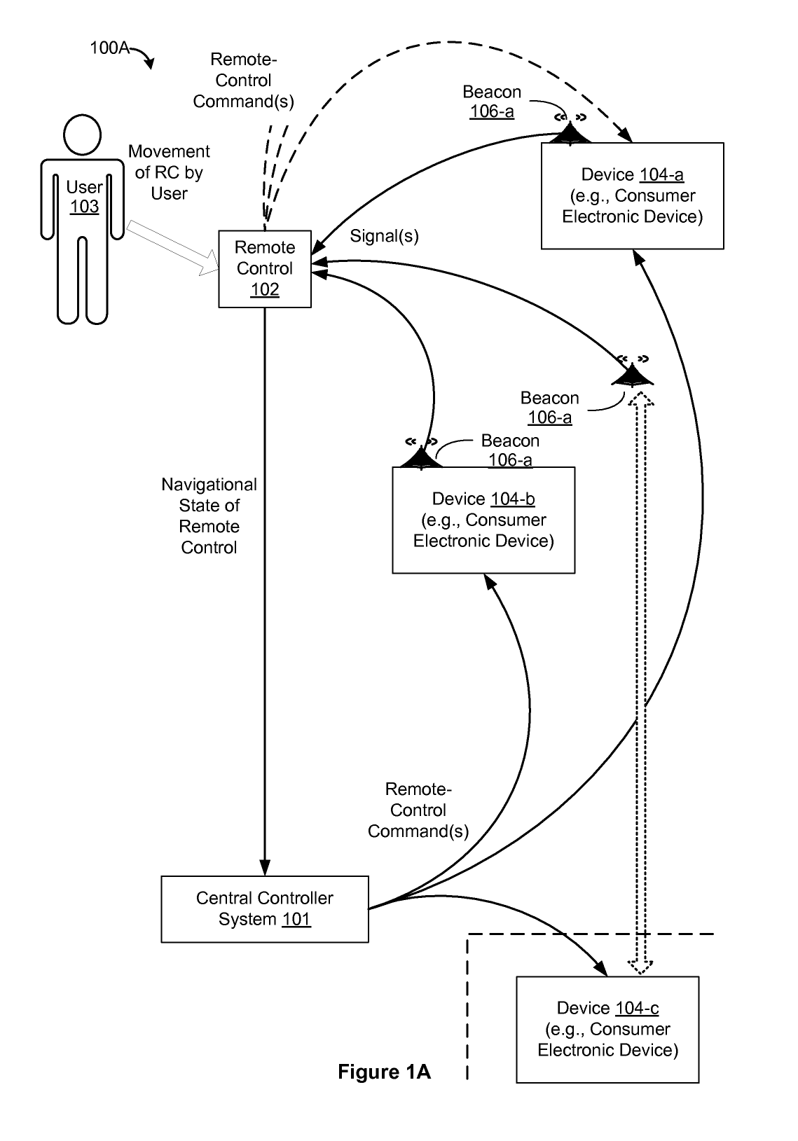

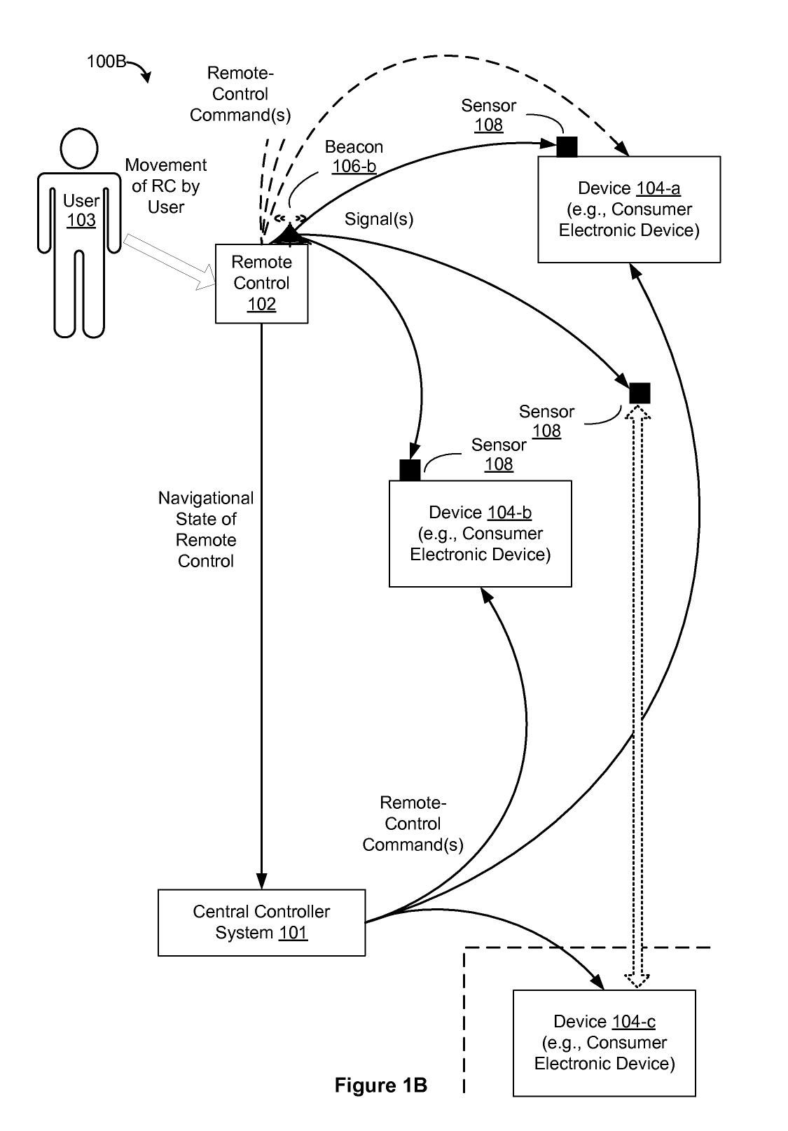

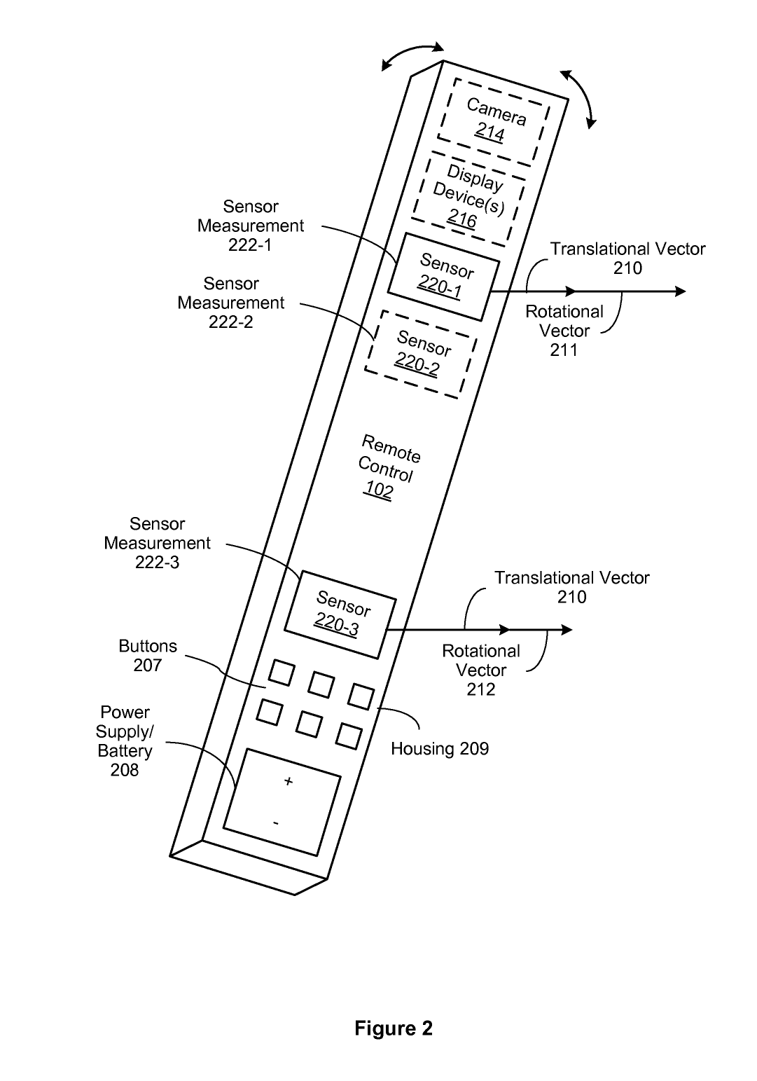

Attention is now directed towards FIGS. 1A-1B, which illustrate exemplary systems 100A and 100B for selecting devices for remote control. As shown in FIGS. 1A-1B, a remote control 102, central controller system 101 and/or devices 104 are coupled to each other via wireless and/or wired interfaces, according to some embodiments. A user 103 moves remote control 102. In some embodiments, these movements are detected by sensors in remote control 102, as described in greater detail below with reference to FIG. 2. Remote control 102, or central controller system 101, generates a navigational state of remote control 102 based on sensor measurements from the sensors. In some embodiments, remote control 102 uses the navigational state to select a device 104 to control and sends remote-control command(s) to the selected device. In some embodiments, remote control 102 transmits the navigational state to a central controller system 101, and central controller system 101 uses the navigational state of remote control 102 to select a device 104 to control. After the selected device is selected, remote control 102 receives an additional input from user 103 (e.g., additional user inputs such as button presses).

In some embodiments, a selected device is a device at which remote control 102 is currently pointed, as determined by the navigational state of the remote control 102. In some embodiments, a respective device 104 has a proxy, which represents the device, so that when remote control 102 is pointed at the proxy, the device represented by the proxy is identified as the selected device. For example, in FIGS. 1A-1B, device 104-a and device 104-b are not represented by proxies, while device 104-c is represented by a proxy.

Remote control 102 generates remote-control command(s) based on the additional input from user 103. The remote-control command(s) are either sent directly to the devices or to a central controller system 101. In some embodiments, remote control 102 sends the remote-control command(s) only to the selected device. In some embodiments, remote control 102 sends the remote-control command(s) to central controller system 101, which sends the remote-control command(s) to the selected device. In other embodiments, remote control 102 transmits remote-control commands to multiple devices (e.g., all devices within range) and central controller system 101 instructs one or more of the devices (e.g., devices other than the selected device) to ignore the remote-control commands. In each of these embodiments, remote control 102 is enabled to control a selected device 104 without inadvertently controlling other devices that are currently within range of remote control 102 but are not the selected device; where the determination of the selected device is based at least in part on a navigational state of remote control 102.

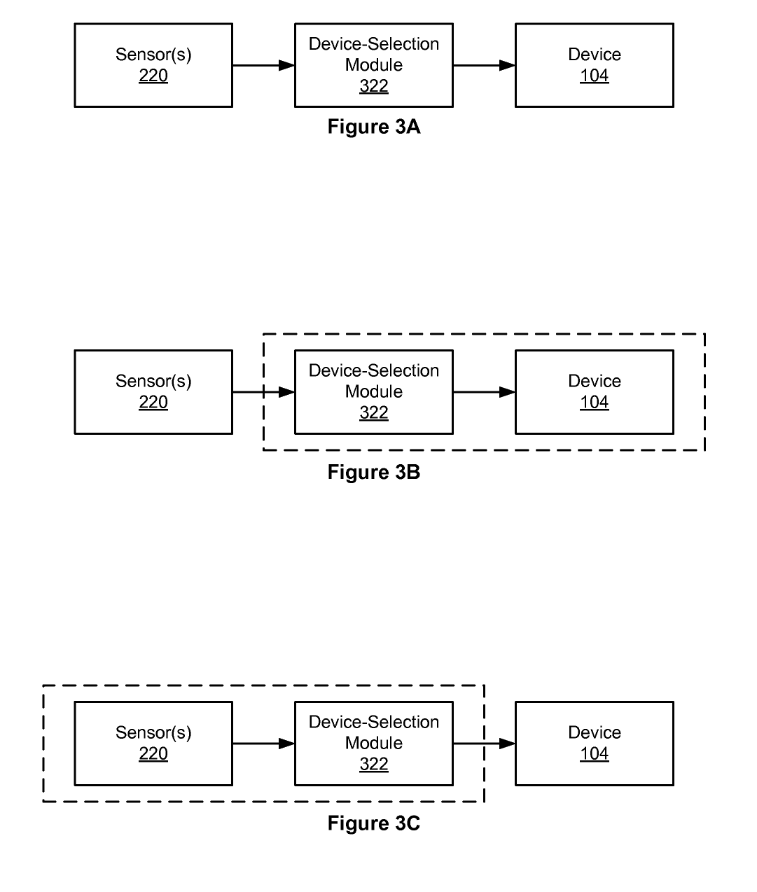

As mentioned above, the selected device is selected in accordance with a navigational state of remote control 102. In some embodiments the navigational state includes an attitude and/or position of the remote relative to the devices. In some embodiments the attitude and/or position are determined using sensors on remote control 102, as illustrated in FIG. 1A. These sensors may include beacon sensors which detect signals from beacons 106-a to determine an attitude and/or position of remote control 102. Beacons 106-a may be located proximate to (e.g., physically attached to or included within) individual devices 104, or one or more beacons 106-a may be separate from devices 104 and merely have known positions with respect to various devices 104. Thus, beacons 106 in FIG. 1A provide a frame of reference for determining the navigational state of remote control 102. In some embodiments the attitude and/or position are determined using sensors 108 on one or more devices 104, as illustrated in FIG. 1B. These sensors may include cameras that can see the device and/or beacon sensors which detect signals from a beacon 106-b on remote control 102 to determine an attitude and/or position of remote control 102. In some embodiments, remote control 102 is sensitive to six degrees of freedom: displacement along the x-axis, displacement along the y-axis, displacement along the z-axis, yaw, pitch, and roll. While remote control 102, central controller system 101 and display device 104 are shown in FIGS. 1A-1B as being separate, in some embodiments the functions of one or more of these elements are combined or rearranged, as described in greater detail below with reference to FIGS. 3A-3C.

In some embodiments, the wireless interface is selected from the group consisting of: a Wi-Fi interface, a Bluetooth interface, an infrared interface, an audio interface, a visible light interface, a radio frequency (RF) interface, and any combination of the aforementioned wireless interfaces. In some embodiments, the wireless interface is a unidirectional wireless interface from remote control 102 to central controller system 101. In some embodiments, the wireless interface is a bidirectional wireless interface. In some embodiments, bidirectional communication is used to perform handshaking and pairing operations. In some embodiments, a wired interface can be used instead of a wireless interface. As with the wireless interface, the wired interface may be a unidirectional or bidirectional wired interface.

In some embodiments, data corresponding to a navigational state of remote control 102 (e.g., raw measurements, calculated attitude, correction factors, position information, etc.) is transmitted from remote control 102 and received and processed on central controller system 101 (e.g., by a “host” side device driver). Central controller system 101 can then use this data to select a selected device and generate remote-control commands (e.g., specifying operations to be performed by a controlled device).

Attention is now directed towards FIG. 2, which illustrates an exemplary remote control 102, according to some embodiments. In accordance with some embodiments, remote control 102 includes one or more sensors 220 which produce sensor outputs 222, which can be used to determine a navigational state of remote control 102 (e.g., two multi-dimensional accelerometers and a multi-dimensional magnetometer, as described in greater detail in U.S. patent application Ser. No. 12/338,996, which is incorporated by reference herein in its entirety). In some embodiments, the remote control also includes buttons 207, a power supply/battery 208, a camera 214 and/or a display device 216 (e.g., a display or projector). In some embodiments, remote control 102 also includes one or more of the following additional user interface components: one or more processors, memory, a keypad, one or more thumb wheels, one or more light-emitting diodes (LEDs), an audio speaker, an audio microphone, a liquid crystal display (LCD), etc. In some embodiments, the various components of remote control 102 (e.g., sensors 220, buttons 207, power supply 208, camera 214 and display device 216) are all enclosed in a housing 209 of remote control 102.

It should be understood that many different types of sensors can be classified as either absolute sensors or relative sensors. As used herein, an absolute sensor is any sensor capable of providing information on the lowest order navigational state in the reference frame of interest. In other words, an absolute sensor is any sensor that can determine a navigational state of a device relative to a reference frame of interest (e.g., a set of stationary RF/magnetic/sonic beacons, a magnetic field, etc.) without requiring knowledge of a previous known navigational state of the device relative to the reference frame of interest.

In contrast, as used herein, a relative sensor is a sensor that provides a measurement of a change in navigational state relative to a previous navigational state. In other words, a relative sensor can be used to determine an amount of change of a quantity of interest (e.g., displacement, rotation, speed, acceleration, etc.) over time, however this change cannot be used to determine a navigational state of the remote control relative to the reference frame of interest without a previous known navigational state relative to the reference frame of interest. In many situations it is advantageous (e.g., because it is less expensive, faster, more efficient, less computationally intensive, etc.) to use relative sensors to track change in the navigational state. However, relative sensors can accumulate a substantial amount of drift between the actual navigational state and the determined/estimated navigational state, which will persist until the sensors are recalibrated by identifying a known navigational state of the sensors in the reference frame of interest (e.g., by moving the user interface device to a known navigational state or using an absolute sensor to determine a navigational state of the remote control.) Thus, typically, some combination of absolute and/or relative sensors is used to determine the navigational state of the remote control. However it should be understood that, in some embodiments (e.g., with sufficiently accurate relative sensors) the navigational state of a remote control could be determined based on a known starting navigational state and input from only relative sensors.

In some embodiments the absolute sensor(s) include a multi-dimensional magnetometer and a multi-dimensional accelerometer (e.g., the frame of reference is the local magnetic field and gravity). In some embodiments the absolute sensor(s) include one or more camera sensors (e.g., the frame of reference is an infra-red light bar or other visual landmarks). In some embodiments the absolute sensor(s) include one or more magnetic beacon sensors (e.g., the frame of reference is one or more magnetic beacons). In some embodiments the absolute sensor(s) include one or more sonic beacon sensors (e.g., the frame of reference is one or more sonic beacons). In some embodiments the absolute sensor(s) include one or more radio-frequency beacon sensors (e.g., the frame of reference is one or more radio-frequency beacons).

In some embodiments the relative sensor(s) include an inertial measurement unit (e.g., a combination of an accelerometer, magnetometer and gyroscope that is used to determine relative position). In some embodiments the relative sensor(s) include a Doppler effect sensor, proximity sensor/switch, odometer, and/or one or more gyroscopes. In some embodiments the relative sensor(s) include one or more accelerometers.

Different combinations of sensors have different trade-offs in terms of price, accuracy, and sample rate. For some applications one particularly advantageous combination of sensors is a first multi-dimensional accelerometer, a second multi-dimensional accelerometer and a multi-dimensional magnetometer, as described in greater detail below. For some other applications one particularly advantageous combination of sensors is a gyroscope (e.g., a MEMS gyroscope), a multi-dimensional accelerometer and a camera (e.g., in combination with an infrared light bar).

In some embodiments, the one or more processors (1102, FIG. 11) of remote control 102 perform one or more of the following operations: sampling measurements 222, at a respective sampling rate, produced by sensors 220; processing sampled data to determine displacement; transmitting displacement information to central controller system 101; monitoring the battery voltage and alerting central controller system 101 when the charge of the battery is low; monitoring other user input devices (e.g., keypads, buttons, etc.), if any, on remote control 102 and, as appropriate, transmitting information identifying user input device events (e.g., button presses) to central controller system 101; continuously or periodically running background processes to maintain or update calibration of sensors 220; providing feedback to the user as needed on the remote (e.g., via LEDs, etc.); and recognizing gestures performed by user movement of remote control 102.

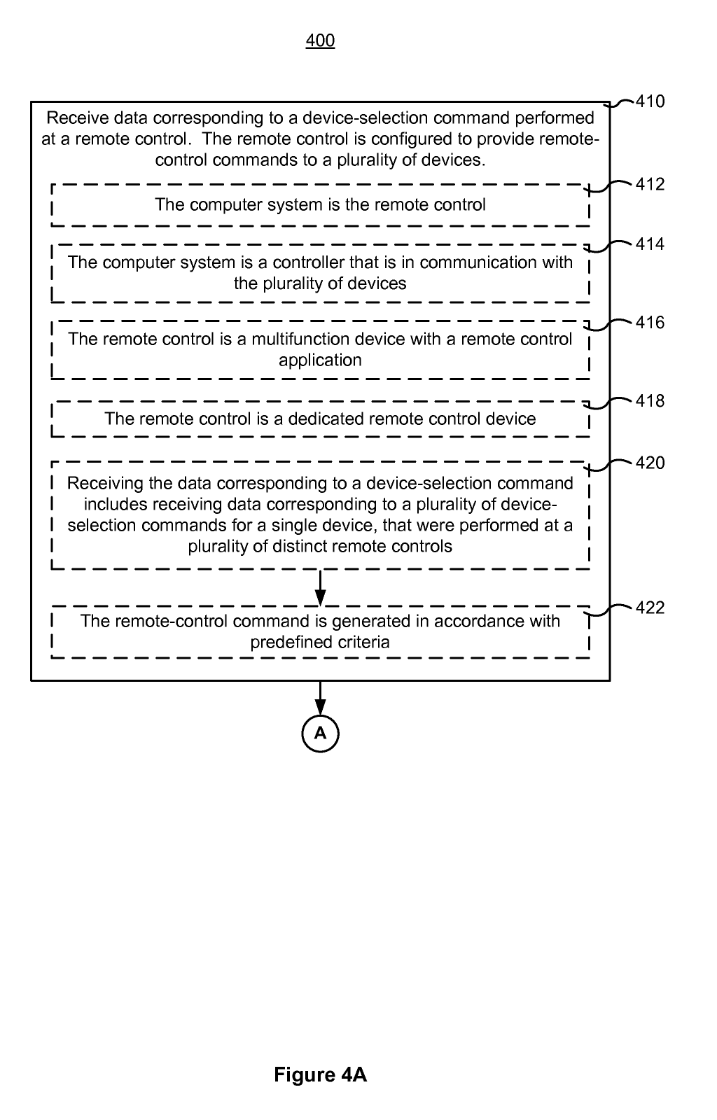

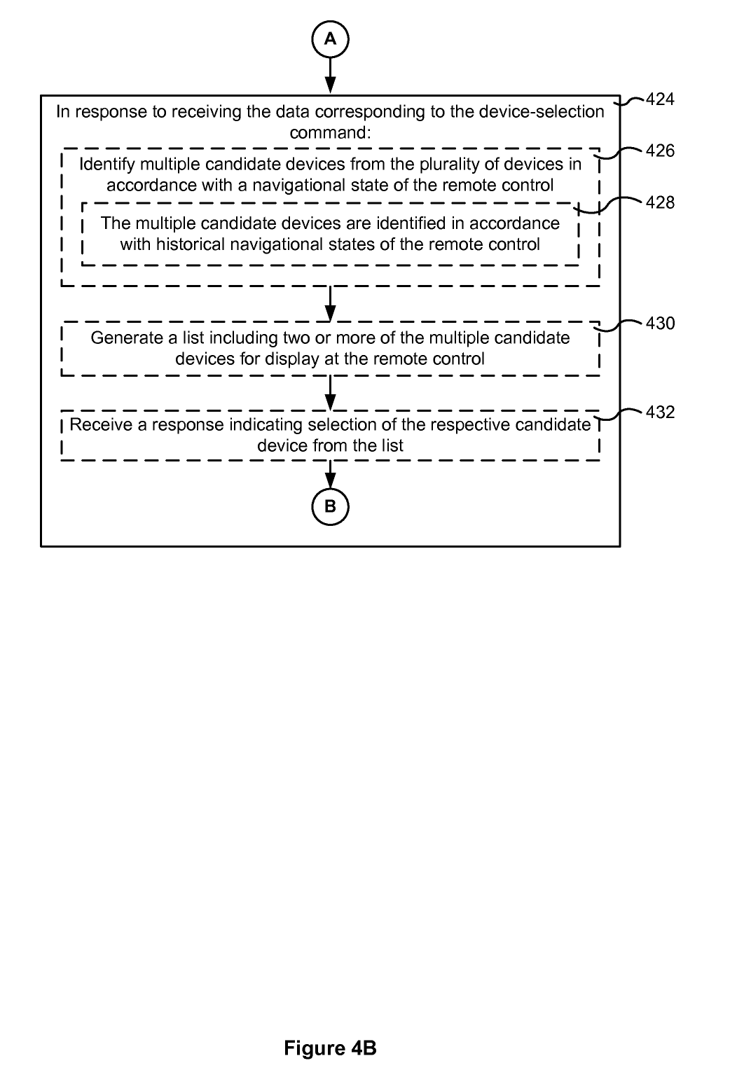

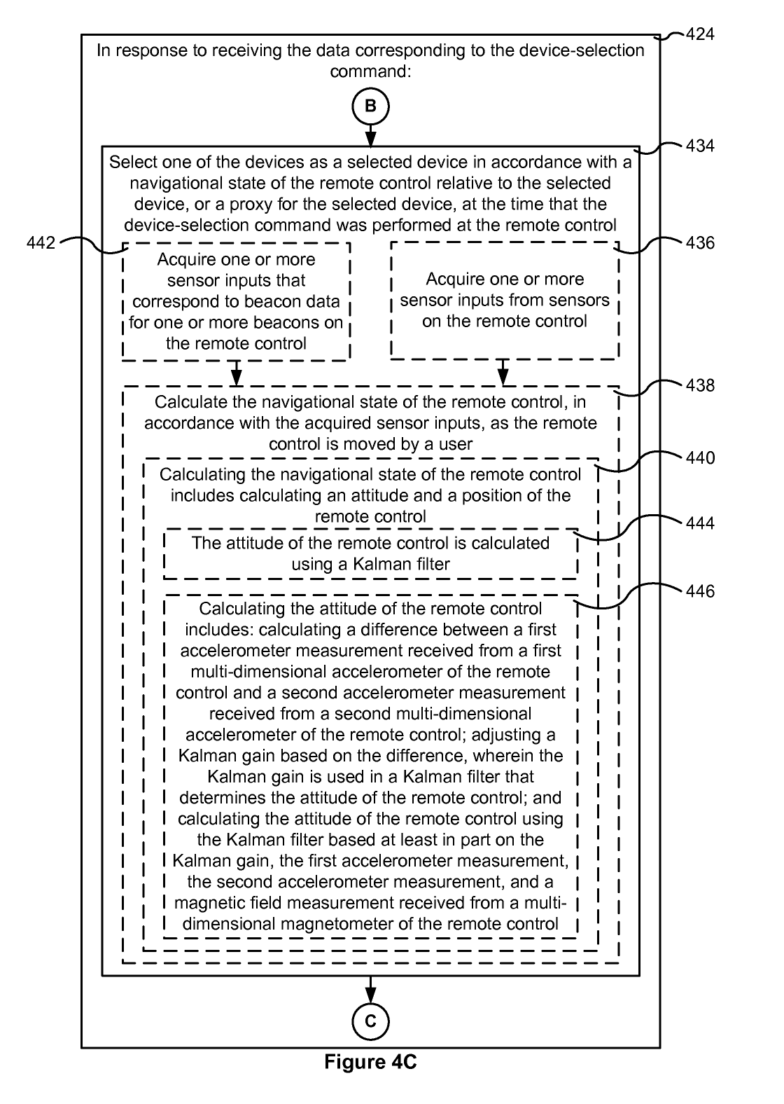

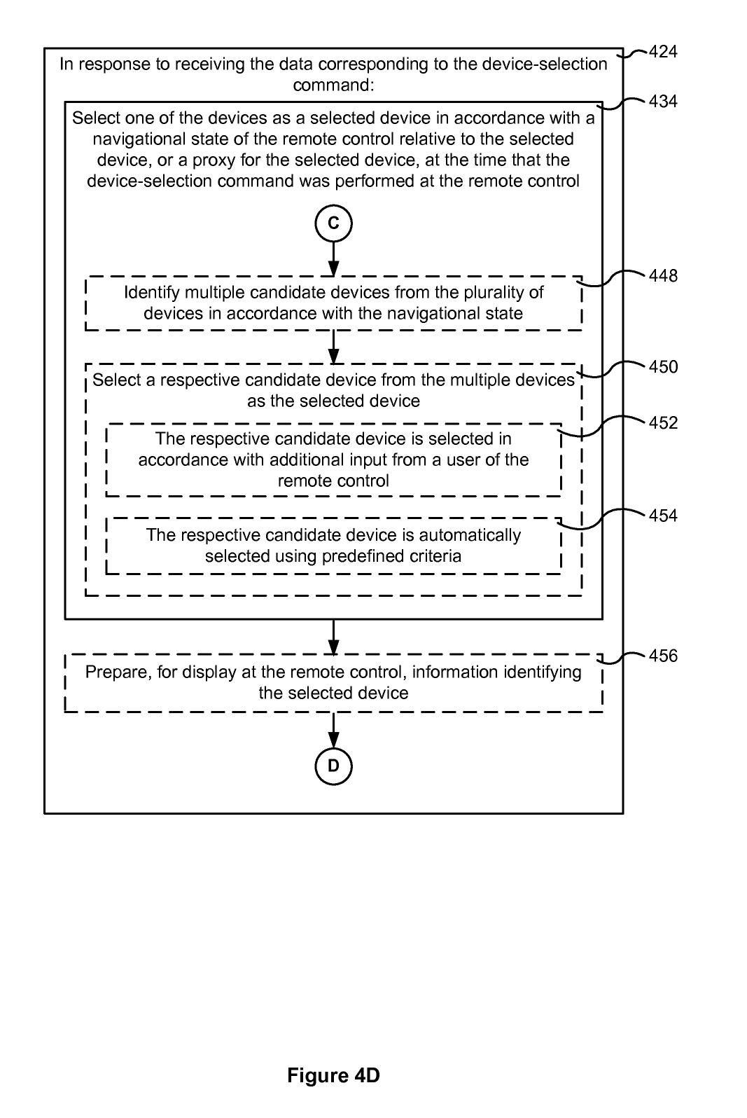

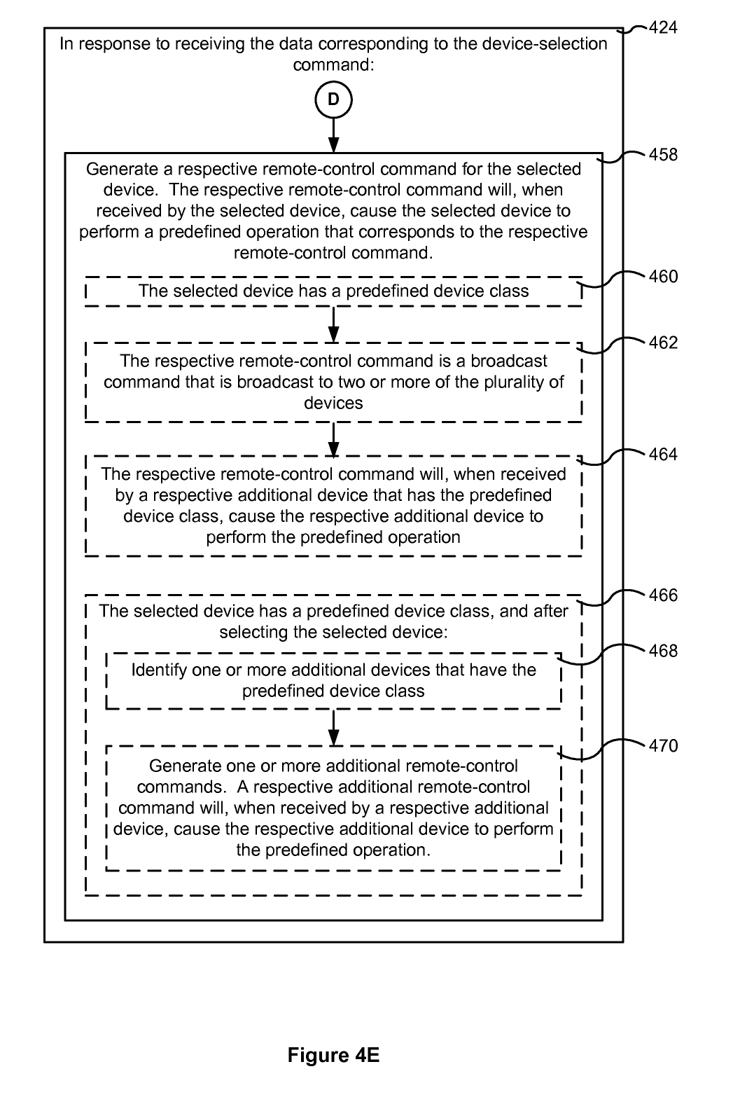

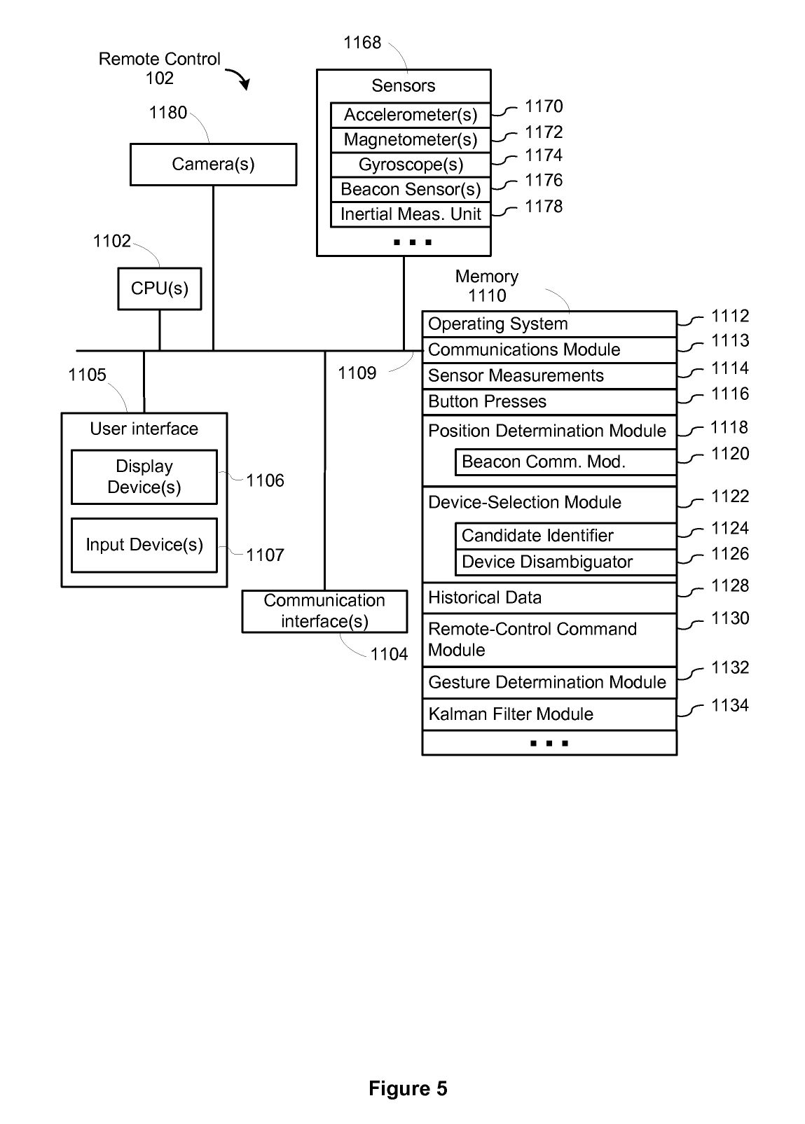

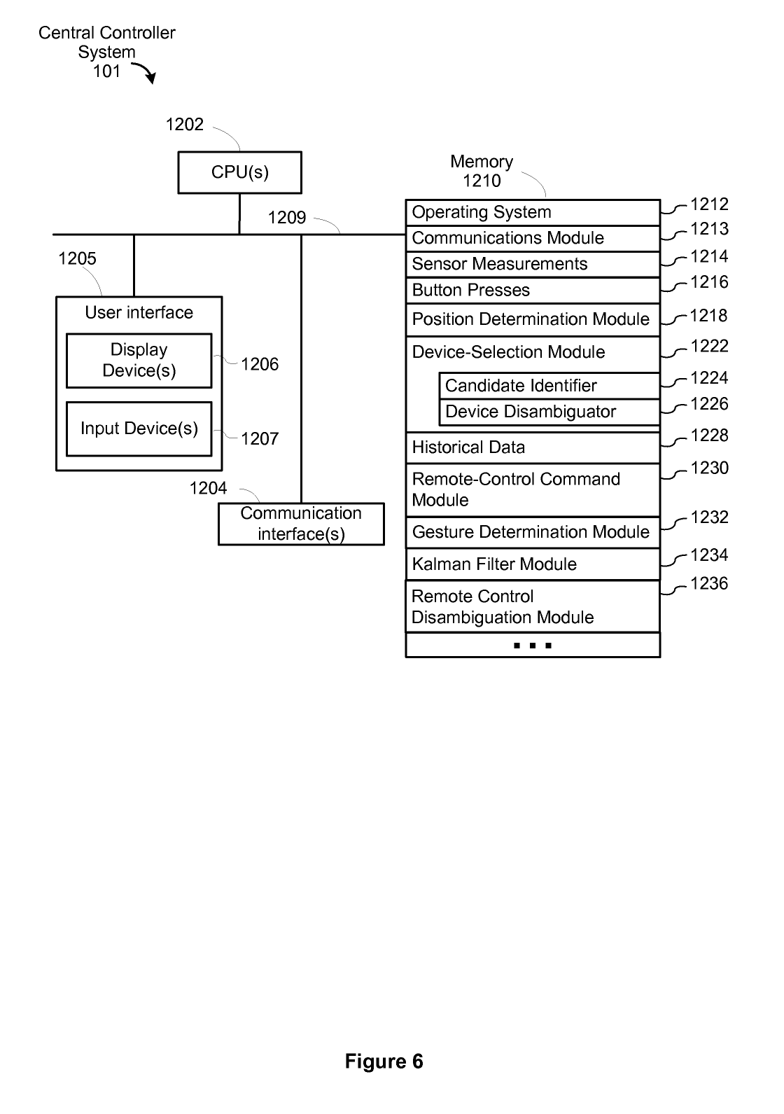

Attention is now directed towards FIGS. 3A-3C, which illustrate configurations of various components of the system for remotely controlling devices, according to some embodiments. In some embodiments, there are three fundamental components to the system for remotely controlling devices described herein: sensors 220, which provide sensor measurements that are used to determine a navigational state of the remote control, device-selection module 322 which uses the navigational state of the remote control to identify a selected device, and device 104, which is the selected device currently being controlled by remote control 102 (FIGS. 1A-1B). It should be understood that these components can be distributed among any number of different devices. Additionally, for the purposes of describing the methods depicted by the flowcharts in FIGS. 4A-4E, the computer system performing the operations to select a selected device (e.g., either the remote control or the central controller system) is the computer system that includes device-selection module 322 (e.g., device selection module 322 is either device-selection module 1122 in remote control 1100 as illustrated in FIG. 5 or device-selection module 1222 in central controller system 101 as illustrated in FIG. 6).

As one example, in FIG. 3A, sensors 220, device-selection module 322 and display device 104 are distributed between three different devices (e.g., a remote control, a home automation control unit, and a television, respectively). As another example, in FIG. 3B, sensors 220 are included in a first device (e.g., a remote control), while the device-selection module 322 and display device 104 are included in a second device (e.g., a central controller system with an integrated display that is itself a consumer electronic device). As another example, in FIG. 3C, sensors 220 and device-selection module 322 are included in a first device (e.g., a “smart” remote control), while display device 104 is included in a second device (e.g., a television). While a plurality of common examples have been described above, it should be understood that the embodiments described herein are not limited to the examples described above, and other distributions of the various components could be made without departing from the scope of the described embodiments.

Selecting a Device for Remote Control

As mentioned above, movement of remote control 102 causes changes to the navigational state of the remote control. These changes are detectable using many different combinations of sensors. For the sake of simplicity and so as not to unnecessarily obscure relevant aspects of the disclosed embodiments, for the description of FIGS. 1A-1B, 2, 3A-3C and 4A-4E, it will be assumed that the remote control includes sensors that are capable of producing measurements that are sufficient to identify a navigational state (e.g., position and/or attitude) of the remote control relative to a known frame of reference with precision that is above a predefined threshold. One method for accurately determining an attitude of a human interface device such as a remote control is described in greater detail in U.S. patent application Ser. No. 12/338,996, which is incorporated herein by reference in its entirety.

Attention is now directed towards FIGS. 4A-4E, which illustrate a method 400 for remotely controlling devices in accordance with a navigational state of a remote control device. The method is performed at a computer system (e.g., remote control 102 or central controller system 101) including one or more processors and memory storing one or more programs, the one or more processors executing the one or more programs to perform one or more of the operations described below. In accordance with some embodiments, the operations described below are performed at remote control 102 (e.g., the computer system is remote control 102), while in accordance with some other embodiments, the operations described below are performed at central controller system 101 (e.g., the computer system is central controller system 101 such as a home automation control unit). Additionally, in some embodiments, one or more of the operations described below are performed at remote control 102 while one or more of the operations described below are performed at central controller system 101. Furthermore, as noted above, in some embodiments the computer system performing the illustrated method includes both remote control 102 and central controller system 101.

The computer system receives (410) data corresponding to a device-selection command performed at a remote control (e.g., 102 in FIGS. 1A-1B, 2 and 5), where the remote control is configured to provide remote-control commands to a plurality of devices. In other words, the remote control is a remote control for multiple different devices, and the computer system determines which of the devices will be controlled by the remote control. In some embodiments, the plurality of devices includes one or more remote controls. For example, a remote control may control a device such as a smart phone that serves as a remote control itself in order to control a third device such as a television or a personal computer.

In some embodiments, the remote-control commands are device-specific remote-control commands. In other words, in these embodiments each device controlled by the remote control has a unique set of remote-control commands and will not respond to remote-control commands intended for other devices. In some other embodiments, the remote-control commands are not device-specific, and thus the same remote-control commands (e.g., sequences of radio frequency (RF)/infrared (IR)/sonic output) could cause different devices to perform respective functions. For example, a particular sequence of IR pulses could cause one television to increase volume and cause another television to change channels. In another example, the particular sequence of IR pulses could cause two separate televisions to increase volume.

In some embodiments, the computer system is (412) the remote control (e.g., the logic for selecting the selected device is included in the remote control). In some embodiments, the computer system is (414) a controller that is in communication with the plurality of devices. In some embodiments, the controller (e.g. a home automation system or other remote control communication unit) may communicate with another controller that communicates with the devices, or subset of devices (e.g., an audio subsystem, multimedia subsystem, kitchen subsystem, etc.). In some embodiments, the remote control is (416) a multifunction device (e.g., a PDA, smart phone, handheld computer or other multi-purpose portable computing device) with a remote control application. In some embodiments, the remote control is (418) a dedicated remote control device. For example, the dedicated remote control device may be a universal remote control or a remote control bundled with a consumer electronic device or a home automation unit which is primarily intended for use as a remote control.

In some embodiments, receiving the data corresponding to a device-selection command includes receiving (420) data corresponding to a plurality of device-selection commands for a single device, that were performed at a plurality of distinct remote controls; and the remote-control command is (422) generated in accordance with predefined criteria (e.g., distance of the remotes from the single device, predefined hierarchy of the remote controls, etc.). In other words, in some situations there will be multiple different remote controls that are all capable of controlling a set of the devices, and the computer system uses some predefined criteria to determine which of the remote controls will be allowed to control which of the devices. For example where two users have remote controls (e.g., smart phones with remote control applications) that each control any of the televisions in a house, when the computer system receives remote-control commands for a television from both of the remote controls, the computer system will determine which remote control will be allowed to control a particular television. The remote control that is allowed to control the particular television will typically be either: the closest remote control to the particular television, the remote control that is pointed at the particular television, the highest priority remote control (determined in accordance with user preferences), or some combination of these factors.

Operations 426-470 are performed (424) in response to receiving the data corresponding to the device-selection command. In some embodiments, the computer system identifies (426) multiple candidate devices from the plurality of devices in accordance with a navigational state of the remote control. In other words, when there are multiple devices that are located proximate to the remote control, it may not be possible for the computer system to determine with sufficient confidence that one of the devices should be the selected device. In these situations, the computer system selects the most likely devices and subsequently makes a selection of a selected device from the candidate devices, as described in greater detail below with reference to operations 448-454.

In some embodiments, the multiple candidate devices are identified (428) in accordance with historical navigational states of the remote control. For example, the computer system may identify paths that have been traveled by remote controls. In addition to showing typical traffic patterns of users, these paths will not pass through walls, thus the computer system will be able to approximately determine the locations of walls and other permanent barriers, and thus will be able to determine which devices are in the same room as the remote control. Once rooms have been identified, the computer system may give preference to remote controls for controlling devices that are located in the same room as the device (e.g., only devices in the same room as the remote control are selected as candidate devices), as it is more likely that a user is attempting to control a device that is located in the same room as the user. Similarly historical temporal data may also be used to give preference to devices that are typically operated around a particular time of day when the device-selection command is received at the particular time of day. For example, a television may be preferred in the evening, while a radio is preferred in the morning if the television is typically operated by the user in the evening and the radio is typically operated by the user in the morning.

In some embodiments, prior to selecting the respective candidate device, the computer system generates (430) a list including two or more of the multiple candidate devices, and receives (432) a response indicating selection of the respective candidate device from the list. In other words, when the computer system identifies multiple candidate devices that the user most likely intended to select (e.g., multiple devices that are within a predefined threshold distance from the device in a particular direction), the computer system provides the user of the remote control with a list of candidate devices, and the selected device is a respective device selected by the user from the list of candidate devices presented to the user.

The computer system selects (434) one of the devices as a selected device in accordance with a navigational state of the remote control relative to the selected device, or a proxy for the selected device, at the time that the device-selection command was performed at the remote control. For example, when there are multiple televisions in a room, and the remote control is pointed at a particular television, the computer system will select the particular television as the selected device, because the television at which the user pointed the remote control is most likely the television that the user intended to control with the remote control. In some embodiments, the navigational state of the remote control is determined based on sensor inputs from the remote control. In some embodiments, the navigational state of the remote control is also based on sensor inputs (e.g., cameras) from other devices. For example, if one or more of the devices has a camera that can see the remote control, that camera may have additional information that will help to more accurately determine a position and/or attitude of the remote control based on the visual appearance of the remote control.

In some embodiments, the navigational state of the remote control is the navigational state of the remote control at the time the operation (e.g., a button press on the remote by the user) that caused the device-select command to be generated was performed. It should be understood that the navigational state of the remote control “at the time that the device select command was performed,” may include either the nearest or next or preceding attitude and/or position determination or a combination/interpolation (e.g., average) of two or more of these navigational states.

While the selected device will typically be selected in accordance with a navigational state of the remote control relative to the selected device, the selected device may also be selected in accordance with a navigational state of the remote control relative to a proxy for the selected device. For example, a user may define one or more objects, symbols or physical positions as a representation/proxy of a particular device. After the user has generated or otherwise established this definition, when the remote control is pointed at the representation/proxy of the particular device, the computer system will treat the particular device as though it were located at the position of the representation/proxy of the particular device (e.g., the particular device will be included in the set of candidate devices or the particular device will be selected as the selected device). As one example of defining a representation/proxy of a particular device, a user may define a picture on a wall in a house as a proxy for a light switch in a garage, and when the remote control is pointed at the picture on the wall, the computer system enables the user to control the light switch in the garage by inputting commands via the remote control (e.g., pressing or tapping an on/off button). In other words, in some embodiments, the proxy is at a location that is different than (e.g., remote from) a location of the selected device.

In some embodiments, the computer system acquires (436) one or more sensor inputs from sensors on the remote control and calculates (438) the navigational state of the remote control, in accordance with the acquired sensor inputs, as the remote control is moved by a user. In some embodiments, calculating the navigational state of the remote control includes calculating (440) an attitude and a position of the remote control. For example, sensors on the remote control (e.g., magnetometers, gyroscopes, accelerometers, beacon sensors, etc.) are used to identify a position and attitude of the remote control relative to the devices, as illustrated in FIG. 1A.

In some embodiments, the computer system acquires (442) one or more sensor inputs that correspond to beacon data for one or more beacons on the remote control and calculates (438) the navigational state of the remote control, in accordance with the acquired sensor inputs, as the remote control is moved by a user. In some embodiments, calculating (440) the navigational state of the remote control includes calculating an attitude and a position of the remote control. In other words, the computer system acquires sensor inputs from devices 104 that are able to observe signals from one or more beacons on remote control 102. For example, signals from one or more beacons (e.g., 106-b in FIG. 1B) on the remote control (e.g., RF beacons, IR beacons, sonic beacons, etc.) are detected by beacon sensors (e.g., 108 in FIG. 1B) that are outside of the remote control (e.g., beacon sensors on the devices) and are used to identify a position and/or attitude of the remote control relative to the devices, as illustrated in FIG. 1B.

In some embodiments, the beacons include one or more different types of beacons, including: sonic beacons, radio frequency (RF) beacons, light (IR) beacons, etc. It should be understood that the sensors and/or the beacons may be on the remote control, on the devices, on the central controller system, or separate from the remote control, devices, and central controller system (e.g., either the sensors or the beacons may be stand-alone sensors or stand-alone beacons); typically, however, at one of the beacons or beacon sensors is on (or in) the remote control. In some embodiments, the navigational state of the remote control is determined in accordance with signals from multiple beacons detected by a single sensor. In some embodiments, the navigational state of the remote control is determined in accordance with signals from a single beacon detected by multiple sensors.

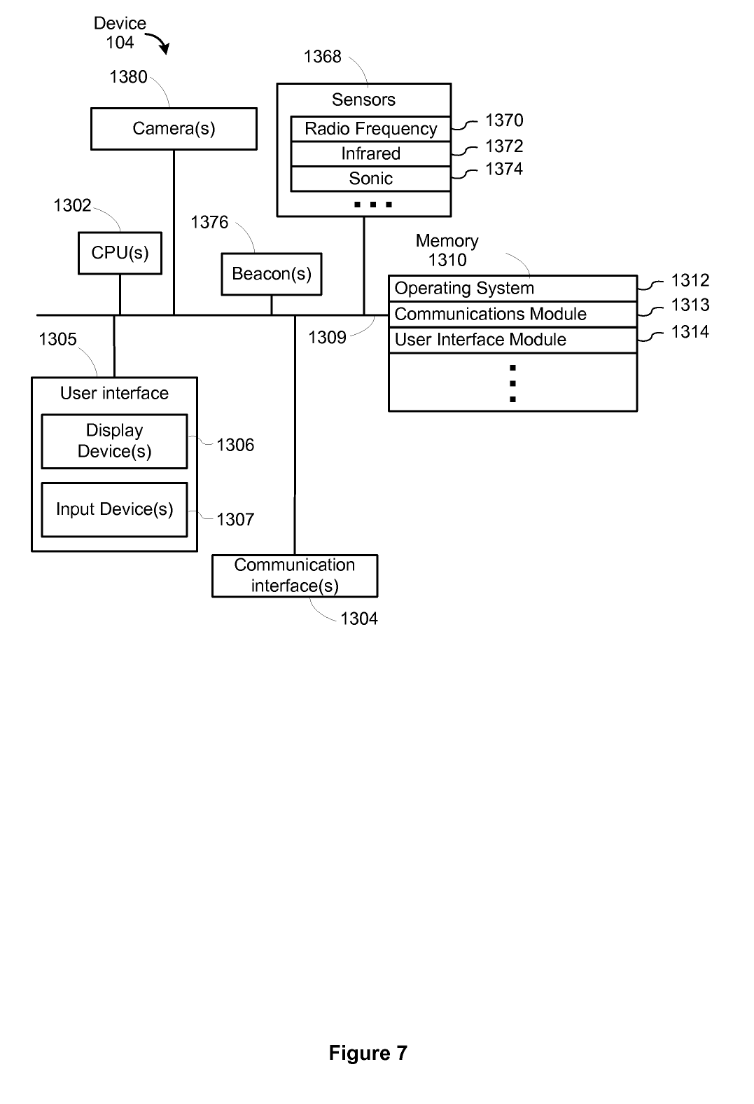

In some embodiments, the navigational state of the remote control includes an attitude and a position of the remote control. In some embodiments, the attitude of the remote control is (444) calculated using a Kalman filter, as described in greater detail in U.S. patent application Ser. No. 12/338,996 (particularly with reference to FIGS. 7-10), which is incorporated by reference herein in its entirety. In some embodiments, calculating the attitude of the remote control includes calculating (446) a difference between a first accelerometer measurement received from a first multi-dimensional accelerometer of the remote control and a second accelerometer measurement received from a second multi-dimensional accelerometer of the remote control, adjusting a Kalman gain based on the difference, where the Kalman gain is used in a Kalman filter that determines the attitude of the remote control, and calculating the attitude of the remote control using the Kalman filter based at least in part on the Kalman gain, the first accelerometer measurement, the second accelerometer measurement, and a magnetic field measurement received from a multi-dimensional magnetometer of the remote control, as described in greater detail in U.S. patent application Ser. No. 12/338,996 (particularly with reference to FIGS. 7-10), which is incorporated by reference herein in its entirety. Also see the description of a method of determining the attitude of the remote control in the Appendix of this document.

In some embodiments, the selecting includes identifying (448) multiple candidate devices from the plurality of devices in accordance with the navigational state; and selecting (450) a respective candidate device from the multiple devices as the selected device. In some of these embodiments, the respective candidate device is selected (452) in accordance with additional input from a user of the remote control. In other words, instead of presenting the user with a list of all of the available devices within the operational range of the remote control, the computer system selects a reduced set of these devices (e.g., the devices that are generally in a direction in which the remote control is pointing), presents to the user a list having the reduced set of devices, and asks the user to select a device from the reduced set of devices, which enables the user to efficiently select a device that the user wants to control. The user then presses a button on the remote control, touches a touch-sensitive display on the remote control, or otherwise provides input to the remote control so as to select a device from the presented list. This embodiment is particularly useful in situations where there are many devices that can be controlled by the remote control and multiple devices are good matches to the navigational state of the remote control. For example, the multiple devices may be positioned close to each other. In these situations, reducing the number of devices from which a user must make a selection reduces the amount of searching required by the user, while still allowing the user to quickly pick the correct device, thereby reducing any delay caused by the computer system selecting the wrong device.

In some other embodiments, or in some circumstances, the respective candidate device is automatically selected (454) using predefined criteria (e.g., distance from the devices, hierarchy of the devices, etc.). In other words, the respective candidate device is selected without further user intervention in accordance with automated procedures at the computer system. These embodiment is particularly useful in situations where there are a lot of devices that can be controlled by the remote control but there is only one device that is a good match to the navigational state of the remote control. In these situations, the matching device can be selected in a single operation, without requiring further input from the user, thereby reducing the number of steps that the user has to perform before the remote control can control the selected device. In some embodiments the respective candidate device is automatically selected when there is only one candidate device that is a good match, while a list of candidate devices is presented to the user if there are multiple candidate devices that are good matches.

Optionally, the computer system prepares (456), for display at the remote control, information identifying the selected device. For example, the remote control displays an indication (e.g., an icon or text on a display or illumination of a button or light on the remote control) that identifies the selected device. Thus, the user is able to determine which device is being controlled by the remote control simply by looking at the indicator on the remote control. Additionally, when the selected device changes (e.g., because the user points the remote control at another device), the indicator of the currently selected device would change to indicate that the other device was the currently selected device.

The computer system generates (458) a respective remote-control command for the selected device, where the respective remote-control command will, when received by the selected device, cause the selected device to perform a predefined operation that corresponds to the respective remote-control command. In some embodiments, the remote-control command prepares the device to receive subsequent remote-control commands directly from the remote control. In some embodiments, the remote-control command causes the device to perform a specific action (e.g., volume adjust, channel adjust, on/off etc.) In other words, after selecting the selected device, the computer system either prepares the selected device to receive additional commands from the remote control, sends commands directly to the selected device, or both.

In some embodiments, the selected device has (460) a predefined device class, which is, optionally, one of a plurality of predefined device classes. It should be understood that when a device “has” a predefined device class, it is a member of that device class. Additionally, a device may have multiple different classes of different scope (e.g., a television may be a “television” device, a “video” device, an “audio” device, an “entertainment center” device, and a “first floor” device). In some of these embodiments, the respective remote-control command is (462) a broadcast command that is broadcast to two or more of the plurality of devices (e.g., the broadcast command is broadcast to a subset of the devices including the selected device and one or more other devices). In some of these embodiments, the respective remote-control command will, when received by a respective additional device that has the predefined device class, cause the respective additional device to perform (464) the predefined operation (e.g., the same predefined operation that was performed by the selected device is performed by all of the devices with the predefined device class).

In some embodiments, the respective remote-control command is sent only to devices that have the predefined device class (e.g., the subset of the plurality of devices consists of the devices that have the predefined class). In some embodiments, the respective remote-control command includes an indicator of the predefined device class so that even when some of the plurality of devices have the predefined device class while other of the devices do not have the predefined device class, only devices with the predefined device class perform operations in response to receiving the respective remote-control command. In particular, when the respective remote-control command is sent to all of the plurality of devices, only those devices that have the predefined device class would perform the predefined operation. As one example, a “mute” command is sent to all devices with a header indicating that the command is intended only for televisions, and in response to the “mute” command, all of the televisions are muted, while other audio devices are not muted. As another example, an “on” command is sent to all devices with a header indicating that the command is intended only for lights, and in response to the “on” command all of the lights are turned on, while none of the other electronic devices are turned on. In this way multiple devices of the same type can be controlled from a single remote control with a single remote-control command.

In some embodiments, the selected device has (466) a predefined device class (e.g., of a plurality of predefined device classes, as described in greater detail above). In some of these embodiments, after selecting the selected device, the computer system identifies (468) one or more additional devices that have the predefined device class (e.g., one or more devices that have the same device class as the device class of the selected device) and generates (470) one or more additional remote-control commands, where a respective additional remote-control command will, when received by a respective additional device, cause the respective additional device to perform the predefined operation (e.g., the same predefined operation that was performed by the selected device). In other words, in some embodiments, in response to receiving the data corresponding to the device-selection command, the computer system selects a first device (e.g., a first light) in accordance with information indicating that the remote control was pointed at the first device (e.g., the first light) at the time that the device-selection command was performed at the remote control, where the selected device is a member of a predefined device class (e.g., “lights”). In these embodiments, the computer system also generates a respective remote-control command for a set of devices that are members of the predefined device class including the first device (e.g., the first light) and a second device (e.g., a second light) different from the first device, where the respective remote-control command will, when received by the first device and the second device, cause the first device and the second device to perform a same predefined operation that corresponds to the respective remote-control command (e.g., turn the first light on and the second light on).

In some embodiments, the additional devices are selected based on the device-selection command that was initially received from the remote control. For example, a first device-selection command only controls the selected device (e.g., turn on/off only the selected device or mute/unmute only the selected device), while a second device-selection command controls the selected device and one or more additional devices (e.g., turn on/off all devices or mute/unmute all audio sources).

Note that method 400 described above may be governed by instructions that are stored in a non-transitory computer readable storage medium and that are executed by one or more processors of a remote control or a central controller system. As noted above, in some embodiments these methods may be performed in part on a remote control and in part on a central controller system, or on a single integrated system which performs all the necessary operations. Each of the operations shown in FIGS. 4A-4E, may correspond to instructions stored in a computer memory or non-transitory computer readable storage medium. The computer readable storage medium may include a magnetic or optical disk storage device, solid state storage devices such as Flash memory, or other non-volatile memory device or devices. The computer readable instructions stored on the computer readable storage medium are in source code, assembly language code, object code, or other instruction format that is interpreted by one or more processors. As described in greater detail above, the computer system could be either remote control 102, central controller system 101 or a combination of the two. An exemplary remote control 1100 is described in greater detail below with reference to FIG. 5. An exemplary central controller system 101 is described in greater detail below with reference to FIG. 6. An exemplary device is described in greater detail below with reference to FIG. 7.

System Structure

FIG. 5 is a block diagram of a remote control 102. Remote control 102 typically includes one or more processing units (CPUs) 1102, one or more network or other communications interfaces 1104 (e.g., a wireless communication interface, as described above with reference to FIGS. 1A-1B), memory 1110, sensors 1168 (e.g., one or more: accelerometers 1170, magnetometers 1172, gyroscopes 1174, beacon sensors 1176, inertial measurement units 1178, etc.), one or more cameras 1180, and one or more communication buses 1109 for interconnecting these components. In some embodiments, communications interfaces 1104 include a transmitter for transmitting information, such as accelerometer and magnetometer measurements, and/or the computed navigational state of remote control 102, and/or other information to a central controller system 101. The communication buses 1109 may include circuitry (sometimes called a chipset) that interconnects and controls communications between system components. Remote control 102 optionally includes a user interface 1105 comprising a display device 1106 (LCD display, LED display, CRT display, projector etc.) and input devices 1107 (e.g., keypads, buttons, etc.). Memory 1110 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1110 may optionally include one or more storage devices remotely located from CPU(s) 1102. Memory 1110, or alternately the non-volatile memory device(s) within memory 1110, comprises a non-transitory computer readable storage medium. In some embodiments, memory 1110 stores the following programs, modules and data structures, or a subset thereof:
an operating system 1112 that includes procedures for handling various basic system services and for performing hardware dependent tasks;
a communication module 1113 that is used for connecting remote control 102 to a central controller system 101 and/or devices 104 via communication network interfaces 1104 (wired or wireless), the communication module optionally may also be adapted for connecting remote control 102 to one or more communication networks, such as the Internet, other wide area networks, local area networks, metropolitan area networks, and so on;
data representing sensor measurements 1114 (e.g., accelerometer measurements, magnetometer measurements, gyroscope measurements, global positioning system measurements, beacon sensor measurements, inertial measurement unit measurements etc.);
data representing button presses 1116;
position determination module 1118, that determines a position of remote control 102 relative to the devices; optionally, the relative position is determined based, at least in part, on inputs from the sensors 1168, and may include beacon communication module 1120 for communicating with beacons;
device-selection module 1122 that selects a selected device from the plurality of devices, and may include candidate identifier 1124 for identifying candidate devices based on a navigational state of remote control 102 and device disambiguator 1126 for either automatically selecting a selected device or requesting additional user input to select a selected device from the candidate devices;
historical data 1128 that represents historical movement paths of remote control 102 that can be used to identify candidate devices (e.g., by determining whether remote control 102 is in the same room as respective devices);
remote-control command module 1130 that generates remote-control commands (e.g., on, off, volume control, channel control, etc.) for controlling various devices in accordance with user inputs;
gesture determination module 1132 optionally determines gestures based on a sequence of navigational states of remote control 102; and
Kalman filter module 1134 that optionally determines the attitude of remote control 102, as described in greater detail in U.S. patent application Ser. No. 12/338,996, which is incorporated by reference in its entirety (particularly with reference to equations 8-29).

It is noted that in some of the embodiments described above, remote control 102 does not include one or more of: position determination module 1118, device-selection module 1122, historical data 1128, remote-control command module 1130, gesture determination module 1132, and/or Kalman filter module 1134 because the various functions performed by these modules and data are either optional, or performed at central controller system 101. For example, remote control 102 may transmit sensor measurements (e.g., accelerometer and magnetometer measurements) and, optionally, button presses 1116 to a central controller system 101 at which one or more of the position determination, attitude determination, device selection, remote-control command generation, gesture determination and other functions are performed.

Each of the above identified elements may be stored in one or more of the previously mentioned memory devices, and each of the above identified programs or modules corresponds to a set of instructions for performing a function described above. The set of instructions can be executed by one or more processors (e.g., CPUs 1102). The above identified modules or programs (i.e., sets of instructions) need not be implemented as separate software programs, procedures or modules, and thus various subsets of these modules may be combined or otherwise re-arranged in various embodiments. In some embodiments, memory 1110 may store a subset of the modules and data structures identified above. Furthermore, memory 1110 may store additional modules and data structures not described above.

Although FIG. 5 shows a “remote control,” FIG. 5 is intended more as functional description of the various features which may be present in a remote control. In practice, and as recognized by those of ordinary skill in the art, items shown separately could be combined and some items could be separated.

FIG. 6 is a block diagram of a central controller system 101. Central controller system 101 typically includes one or more processing units (CPU's) 1202, one or more network or other communications interfaces 1204 (e.g., any of the wireless interfaces described above with reference to FIGS. 1A-1B), memory 1210, and one or more communication buses 1209 for interconnecting these components. In some embodiments, communications interfaces 1204 include a receiver for receiving information, such as accelerometer and magnetometer measurements, and/or the computed attitude of remote control 102, and/or other information from remote control 102. Communication buses 1209 may include circuitry (sometimes called a chipset) that interconnects and controls communications between system components. Central controller system 101 optionally may include a user interface 1205 comprising a display device 1206 (LCD display, LED display, CRT display, projector, etc.) and input devices 1207 (e.g., one or more of the following: a mouse, a keyboard, a trackpad, a trackball, a keypad, buttons, a remote control having keypad buttons or other input devices, etc.). Memory 1210 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1210 may optionally include one or more storage devices remotely located from CPU(s) 1202. Memory 1210, or alternately the non-volatile memory device(s) within memory 1210, comprises a non-transitory computer readable storage medium. In some embodiments, memory 1210 stores the following programs, modules and data structures, or a subset thereof:
an operating system 1212 that includes procedures for handling various basic system services and for performing hardware dependent tasks;
a communication module 1213 that is used for connecting central controller system 101 to a remote control 102, and other devices 104 or systems via communication network interfaces 1204 (wired or wireless), and for connecting central controller system 101 to one or more communication networks, such as the Internet, other wide area networks, local area networks, metropolitan area networks, and so on;
optionally, data representing sensor measurements 1214 (e.g., accelerometer measurements, magnetometer measurements, gyroscope measurements, global positioning system measurements, beacon sensor measurements, inertial measurement unit measurements etc. received from remote control 102 or devices 104);
data representing button presses 1216 (e.g., received from remote control 102);
position determination module 1218, that determines a position of remote control 102 relative to devices 104 based on inputs from sensors on remote control 102 or devices 104;
device-selection module 1222 that selects a selected device from the plurality of devices, and may include candidate identifier 1224 for identifying candidate devices based on a navigational state of remote control 102 and device disambiguator 1226 for either automatically selecting a selected device or requesting additional user input to select a selected device from the candidate devices;
optionally, historical data 1228 that represents historical movement paths of remote control 102 that can be used to select candidate devices (e.g., by determining whether remote control 102 is in the same room as respective devices);
remote-control command module 1230 that generates remote-control commands (e.g., on, off, volume control, channel control, etc.) for controlling various devices in accordance with user inputs;
optionally, gesture determination module 1232, which determines gestures based on a sequence of navigational states of remote control 102;
optionally, Kalman filter module 1234, which determines the attitude of remote control 102, as described in greater detail in U.S. patent application Ser. No. 12/338,996, which is incorporated by reference in its entirety (particularly with reference to equations 8-29); and
optionally, remote control disambiguation module 1236 that identifies data received from a plurality of different remote controls and determines which remote control will be enabled to control which device.

It is noted that in some of the embodiments described above, central controller system 101 does not include one or more of: position determination module 1218, device-selection module 1222, historical data 1228, remote-control command module 1230, gesture determination module 1232, and/or Kalman filter module 1134 because the various functions performed by these modules and data are instead performed at remote control 102. In other words, remote control 102 may process sensor measurements (e.g., accelerometer and magnetometer measurements), button presses and other data and transmit remote control navigational state information and/or device selection information to central controller system 101, which uses the information to control devices 104, as described in greater detail above.

Each of the above identified elements may be stored in one or more of the previously mentioned memory devices, and each of the above identified programs or modules corresponds to a set of instructions for performing a function described above. The set of instructions can be executed by one or more processors (e.g., CPUs 1202). The above identified modules or programs (i.e., sets of instructions) need not be implemented as separate software programs, procedures or modules, and thus various subsets of these modules may be combined or otherwise re-arranged in various embodiments. The actual number of processors and software modules used to implement central controller system 101 and how features are allocated among them will vary from one implementation to another. In some embodiments, memory 1210 may store a subset of the modules and data structures identified above. Furthermore, memory 1210 may store additional modules and data structures not described above.

FIG. 7 is a block diagram of a device 104 (e.g., a consumer electronic device such as a home audio system or a television). Device 104 typically includes one or more processing units (CPU's) 1302, one or more network or other communications interfaces 1304 (e.g., any of the wireless interfaces described above with reference to FIGS. 1A-1B), memory 1310, and sensors 1368 (e.g., radio frequency sensors 1370, infrared sensors 1372, and/or sonic sensors 1374). Device 104 optionally includes one or more beacons 1376, and optionally includes one or more cameras 1380, as discussed above. Device 104 further includes one or more communication buses 1309 for interconnecting these components. In some embodiments, communications interfaces 1304 include a receiver for receiving information, such as remote-control commands from remote control 102 or central controller system 101. Communication buses 1309 may include circuitry (sometimes called a chipset) that interconnects and controls communications between system components.

Device 104 optionally includes a user interface 1305 comprising a display device 1306 (LCD display, LED display, CRT display, projector, etc.) and input devices 1307 (e.g., remote control such as a multi-dimensional pointer, a mouse, a keyboard, a trackpad, a trackball, a keypad, buttons, etc.). Memory 1310 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1310 may optionally include one or more storage devices remotely located from CPU(s) 1302. Memory 1310, or alternately the non-volatile memory device(s) within memory 1310, comprises a non-transitory computer readable storage medium. In some embodiments, memory 1310 stores the following programs, modules and data structures, or a subset thereof:
an operating system 1312 that includes procedures for handling various basic system services and for performing hardware dependent tasks;
a communication module 1313 that is used for connecting device 104 to remote control 102, central controller system 101 and/or other devices 104 via communication network interfaces 1304 (wired or wireless), and for connecting device 104 to one or more communication networks, such as the Internet, other wide area networks, local area networks, metropolitan area networks, and so on; and
a user interface module 1314 that receives commands from the user via the input devices 1307 and remote control 102 and performs operations in accordance with the commands (e.g., adjusting volume, turning on or off, changing channels, etc.).

Each of the above identified elements may be stored in one or more of the previously mentioned memory devices, and each of the above identified programs or modules corresponds to a set of instructions for performing a function described above. The set of instructions can be executed by one or more processors (e.g., CPUs 1302). The above identified modules or programs (i.e., sets of instructions) need not be implemented as separate software programs, procedures or modules, and thus various subsets of these modules may be combined or otherwise re-arranged in various embodiments. The actual number of processors and software modules used to implement device 104 and how features are allocated among them will vary from one implementation to another. In some embodiments, memory 1310 may store a subset of the modules and data structures identified above. Furthermore, memory 1310 may store additional modules and data structures not described above.

While the descriptions provided above address various methods and systems for selecting a device for remote control in accordance with a navigational state of a remote control, the descriptions provided below address how to determine the navigational state of a remote control based on sensor measurements. One method for accurately determining an attitude of a human interface device such as a remote control is described in greater detail in U.S. patent application Ser. No. 12/338,996, which is incorporated by reference in its entirety.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

### APPENDIX

Accurately determining a navigational state of a remote control is a non-trivial problem. While a number of different approaches to determining a navigational state of a remote control are known in the art, many of these approaches are either prohibitively expensive, insufficiently accurate or suffer from other flaws that make them unsuitable for use with the remote control (e.g., 102, 1100) described herein. As such, in order to provide a more complete description of the disclosed embodiments, an exemplary remote control 200 including one or more multi-dimensional magnetometers and two or more multi-dimensional accelerometers that are used to inexpensively and accurately determine the attitude of remote control 200 is described below. It should be understood that remote control 200 is a particular embodiment of the remote controls 102, 1100 described above.

### Attitude Determination

One problem with accurately determining a navigational state (e.g., position and/or attitude) of a remote control is that the movement of remote control 200 causes accelerations and decelerations that may cause conventional attitude-determination techniques to fail. Specifically, consider a device that includes a single multi-dimensional magnetometer (e.g., a tri-axial magnetometer) and a single multi-dimensional accelerometer (e.g., a tri-axial accelerometer), which is subject to dynamic acceleration. Note that the term “dynamic acceleration” refers to acceleration and/or deceleration (e.g., accelerations/decelerations during movement of the device). Applying the TRIAD technique to magnetic field measurements from a single multi-dimensional magnetometer and acceleration measurements from a single multi-dimensional accelerometer results in attitude measurements that include errors. The errors arise because the TRIAD technique depends on a constant relationship between the Earth's magnetic field and gravity. Consequently, the TRIAD technique only produces correct attitude measurements when the device is not undergoing dynamic acceleration (e.g., at rest or at constant velocity). If the device is being accelerated, the acceleration measurement includes a combination of gravity and the acceleration imparted by movements of the device. Using this acceleration measurement to represent the Earth's gravity produces substantial errors in the computed attitude. These problems are described in more detail with respect to FIGS. 11-13 below.

One solution is to use a remote control that includes a gyroscope (e.g., a MEMS gyroscope). However, the physics of the gyroscopes can cause artifacts. For example, these types of remote controls can drift when the device is held in a stationary position. Furthermore, these remote controls can require substantial force before the device produces a reaction in the user interface.

Thus, to solve the aforementioned problems, some embodiments use magnetic field measurements from one or more multi-dimensional magnetometers and acceleration measurements from two or more multi-dimensional accelerometers that are included in a remote control to calculate the attitude of the device. In these embodiments, the calculated attitude of the remote control is compensated for errors that would otherwise be caused by dynamic acceleration. In some embodiments, the multi-dimensional accelerometers are placed a specified distance apart in a rigid frame (e.g., a printed circuit board on the device). When the remote control is rotated, the multi-dimensional accelerometers experience different accelerations due to their different radiuses of rotation. Note that when the frame is moved in translation (e.g., without rotation), all the accelerometers experience the same acceleration. It is then possible to use the differences in the accelerometer readings to distinguish between user movement (e.g., dynamic acceleration) and the acceleration caused by Earth's gravity to correctly estimate the attitude of the device.

FIG. 8 is a block diagram illustrating an exemplary remote control 200, according to some embodiments. In accordance with some embodiments, remote control 200 includes two or more multi-dimensional accelerometers 201-202 that produce composite acceleration measurements 204-205 (e.g., a composite/vector sum of translational acceleration vectors 210, rotational acceleration vectors 211-212, and acceleration due to Earth's gravity), one or more multi-dimensional magnetometers 203 that produce magnetic field measurements 206 (e.g., the Earth's magnetic field), buttons 207, a power supply and/or battery 208, a camera 214 and one or more display devices (e.g., displays and/or projectors). In some embodiments, the two or more multi-dimensional accelerometers 201-202 that produce acceleration measurements 204-205, one or more multi-dimensional magnetometers 203 that produce the magnetic field measurements 206, buttons 207, and the power supply or battery 208 are all enclosed in a housing 209 of remote control 200.

In some embodiments, the two or more multi-dimensional accelerometers 201-202 are selected from the group consisting of: a 2-axis accelerometer that measures a magnitude and a direction of an acceleration force in two dimensions and a 3-axis accelerometer that measures a magnitude and a direction of an acceleration force in three dimensions.

In some embodiments, the one or more multi-dimensional magnetometers 203 are selected from the group consisting of: a 2-axis magnetometer that measures a magnitude and a direction of a magnetic field in two dimensions and a 3-axis magnetometer that measures a magnitude and a direction of a magnetic field in three dimensions.

In some embodiments, remote control 200 also includes one or more of the following additional user interface components: a keypad, one or more thumb wheels, one or more light-emitting diodes (LEDs), a audio speaker, an audio microphone, a liquid crystal display (LCD), a projector, etc.

In some embodiments, remote control 200 includes one or more processors. In these embodiments, the one or more processors process the acceleration measurements received from multi-dimensional accelerometers 201-202 and/or magnetic field measurements received from multi-dimensional magnetometer 203 to determine displacements (e.g., lateral displacements and/or attitude changes) of remote control 200. These calculations are described in more detail with respect to FIGS. 14-16 below.

In some embodiments, the one or more processors of remote control 200 perform one or more of the following operations: sampling measurement values, at a respective sampling rate, produced by each of the multi-dimensional accelerometers 201-202 and the multi-dimensional magnetometers 203; processing sampled data to determine displacement; transmitting displacement information to central controller system 101; monitoring the battery voltage and alerting central controller system 101 when the charge of the battery is low; monitoring other user input devices (e.g., keypads, buttons, etc.), if any, on remote control 200 (sometimes called a multi-dimensional pointing device); continuously or periodically run background processes to maintain or update calibration of the multi-dimensional accelerometers 201-202 and the multi-dimensional magnetometers 203; provide feedback to the user as needed on the remote (e.g., via LEDs, etc.); and recognizing gestures performed by user movement of the multi-dimensional pointing device (remote control 200).

### Software Architecture

FIG. 9 is a block diagram illustrating an exemplary software architecture 300 for the central controller system (e.g., 101 or 1200). The software architecture 300 includes a monitor application 301 to receive either accelerometer and magnetometer measurements or attitude measurements from remote control 200, depending on whether remote control 200 or the central controller system processes the measurements so as to produce attitude measurements. The software architecture also includes a program/file directory 302 (e.g., an electronic program guide, etc.) that includes information about programs and/or media files (e.g., titles, times, channels, etc.), a video-on-demand application 303 that provides access to one or more video-on-demand services, online applications 304 that provide access to applications provided by a service provider (e.g., cable/satellite television providers, Internet service providers, Internet websites, game providers, online multimedia providers, etc.), and terminal based applications 305 that are (or that provide access to) applications that are resident on central controller system 101 (e.g., games that are played on the central controller system, Internet browsing applications, multimedia viewing and/or sharing applications, email applications, etc.). In some embodiments, the remote control 200 includes a subset of these applications. Furthermore, the remote control 200 may include additional applications, modules and data structures not described above.

The software architecture 300 also includes an operating system (e.g., OpenCable Application Platform (OCAP), Windows, Linux, etc.) 310, which includes an execution engine (or virtual machine) 311 that executes applications, an optional API 312 for communicating with a remote control that does not conform to a human interface standard implemented in the operating system 310, middleware 313 that provides management of the resources of central controller system 101 (e.g., allocation of memory, access to access hardware, etc.) and services that connect software components and/or applications, respectively, and central controller system device drivers 314. In some embodiments, central controller system device drivers 314 adjust the gain of remote control 200 based on the resolution and/or aspect ratio of the display of central controller system 101, translates physical movement of remote control 200 to movement of a cursor (or an object) within the user interface of central controller system 101, allows central controller system applications to adjust cursor movement sensitivity, and/or reports hardware errors (e.g., a battery low condition, etc.) to middleware 313.

In some embodiments, remote control 200 periodically samples its sensors. Remote control 200 may also periodically provide the sampled sensor data to the central controller system (e.g., 101 or 1200) at a respective update rate. To reduce power consumption caused by transmitting data to central controller system 101, the update rate may be set at a substantially smaller rate than the sampling rate. Note that the minimum update rate may be governed by the frame rate of the display of the central controller system (e.g., 25 Hz in Europe and 30 Hz in the United States and Asia). Note that there may be no perceivable advantage in providing faster updates than the frame rate except when the transmission media is lossy.

In some embodiments, remote control 200 uses digital signal processing techniques. Thus, the sampling rate must be set high enough to avoid aliasing errors. Movements typically occur at or below 10 Hz, but AC power can create ambient magnetic field fluctuations at 50-60 Hz that can be picked up by a magnetometer. For example, to make sure there is sufficient attenuation above 10 Hz, remote control 200 may use a 100 Hz sampling rate and a 50 Hz update rate.

In some embodiments, remote control 200 reports raw acceleration and magnetic field measurements to central controller system 101. In these embodiments, the central controller system device drivers 314 calculate lateral and/or angular displacements based on the measurements. The lateral and/or angular displacements are then translated to cursor movements based on the size and/or the resolution of the display of central controller system 101. In some embodiments, central controller system device drivers 314 use a discrete representation of angular displacement to perform sampling rate conversion to smoothly convert from the physical resolution of remote control 200 (e.g., the resolution of the accelerometers and/or the magnetometers) to the resolution of the display.

In some embodiments, central controller system device drivers 314 interpret a sequence of movements (e.g., changes in attitude, displacements, etc.) as a gesture. For example, the user 103 may use remote control 200 to move a cursor in a user interface of central controller system 101 so that the cursor points to a dial on the display of central controller system 101. The user 103 can then select the dial (e.g., by pressing a button on remote control 200) and turn remote control 200 clockwise or counter-clockwise (e.g., roll) to activate a virtual knob that changes the brightness, contrast, volume, etc., of a television set. Thus, the user 103 may use a combination or sequence of keypad presses and pointing device movements to convey commands to the central controller system. Similarly, the user 103 may use a twist of a wrist to select the corner of a selected image (or video) for sizing purposes. Note that the corner of an image may be close to another active object. Thus, selecting the image may require careful manipulation of remote control 200 and could be a tiresome exercise. In these cases, using a roll movement as a context sensitive select button may reduce the accuracy users need to maintain with the movement of remote control 200.

In some embodiments, remote control 200 computes the physical displacement of the device and transmits the physical displacement of the device to central controller system 101. Central controller system device drivers 314 interpret the displacement as cursor movements and/or gestures. Thus, central controller system device drivers 314 can be periodically updated with new gestures and/or commands to improve user experience without having to update the firmware in remote control 200.

In some other embodiments, remote control 200 computes the physical displacement of the device and interprets the displacements as cursor movements and/or gestures. The determined cursor movements and/or gestures are then transmitted to central controller system 101.

In some embodiments, remote control 200 reports its physical spatial (e.g., lateral and/or angular) displacements based on a fixed spatial resolution to central controller system 101. Central controller system device drivers 314 interpret the distance and/or angle traversed into appropriate cursor movements based on the size of the display and/or the resolution of the display. These calculated displacements are then translated into cursor movements in the user interface of central controller system 101.

Although remote control 200 may provide data (e.g., position/displacement information, raw measurements, etc.) to central controller system 101 at a rate greater than the frame rate of a display of central controller system 101, the central controller system device drivers 314 needs to be robust enough to accommodate situations where packet transmission fails. In some embodiments, each packet received from remote control 200 is time stamped so that central controller system device drivers 314 can extrapolate or interpolate missing data. This time stamp information may also be used for gesture recognition to compensate for a lossy transmission media.

In some embodiments, remote control 200 omits packets to conserve power and/or bandwidth. In some embodiments, remote control 200 omits packets to conserve power and/or bandwidth only if it is determined that central controller system device drivers 314 can recreate the lost packets with minimal error. For example, remote control 200 may determine that packets may be omitted if the same extrapolation algorithm is running on central controller system 101 and on remote control 200. In these cases, remote control 200 may compare the real coordinates against the extrapolated coordinates and omit the transmission of specified packets of data if the extrapolated coordinates and the real coordinates are substantially similar.

In some embodiments, remote control 200 includes a plurality of buttons. The plurality of buttons allows users that prefer a conventional user interface (e.g., arrow keys, etc.) to continue using the conventional user interface. In these embodiments, central controller system device drivers 314 may need to interpret a combination of these buttons as a single event to be conveyed to middleware 313 of the central controller system.

In some embodiments, central controller system device drivers 314 are configured so that remote control 200 is treated by central controller system 101 as a two-dimensional pointing device (e.g., mouse, trackpad, trackball, etc.).

FIG. 10 is a block diagram illustrating inputs, outputs, and operations of an exemplary device-side firmware 400 for remote control 200, according to some embodiments. Sensors 401 generate measurements that may be sampled by one or more sampling circuits 402.

In some embodiments, the sampled sensor measurements are packetized for transmission 407 and transmitted to central controller system 101 by a transmitter 408.

In some embodiments, sensors 401 are calibrated and corrected 403. For example, the sensors 401 may be calibrated and corrected so that a Kalman filter that is used to compute the attitude of a remote control (e.g., the remote control 200 in FIG. 8, etc.) is initialized with a zero assumed error. The Kalman filter states are then determined 404. The determined Kalman filter states are then mapped to physical coordinates 405, and data representing the physical coordinates are packetized for transmission 407 by the transmitter 408. Keypad and other inputs 406 may also be packetized for transmission 407 and transmitted by the transmitter 408. In some embodiments, the keypad and/or other inputs 406 are used in conjunction movements of the remote control 200 to produce gestures that convey commands to a central controller system. In some of these embodiments, the keypad and other inputs 406 are mapped to physical coordinates 405 (e.g., noting the physical coordinates at which the keypad and other inputs were activated) prior to being packetized for transmission 407. Alternately, the time ordered sequence in which keypad presses (or other inputs) and changes in position of the remote control 200 are packetized and transmitted to the central controller system is used by the device to determine the context of the keypad presses (or other inputs) and to determine what gesture(s) were performed by the user.

The measurements from the sensors and the determined change in position and/or attitude may also be used to enter and/or exit sleep and wake-on-movement modes 409.

In some embodiments, remote control 200 measures rotations of the remote control over a physical space that is independent of the size, distance and direction of the display of central controller system 101. In fact, remote control 200 may report only displacements between two consecutive samples in time. Thus, the orientation of remote control 200 does not matter. For example, yaw may be mapped to left/right cursor movement and pitch may be mapped to up/down cursor movements.

In some embodiments, to conserve system power, remote control 200 detects a lack of movement of remote control 200 for more than a predetermined time period and puts itself into a low power (e.g., sleep) mode. In some embodiments, a single accelerometer is used to sense whether remote control 200 is being moved and to generate an interrupt to wake (e.g., wake-on-demand) remote control 200 from the sleep mode.

In some embodiments, remote control 200 determines that it should enter a sleep mode based on one or more of the following conditions: the magnitude of the acceleration measurement (e.g., A_{observed}) is not greater or smaller than the magnitude of Earth's gravity (e.g., G) by a specified threshold, the standard deviation of A_{observed} does not exceed a specified threshold, and/or there is an absence of change in the angular relationship between the measurement of the Earth's magnetic field (e.g., B) and A_{observed} greater than a specified threshold. Each of the aforementioned conditions may be used to indicate that the remote control 200 has entered a resting state (e.g., no substantial movement). After remote control 200 has remained in a resting state for a specified number of consecutive samples, remote control 200 enters a sleep mode.

In some embodiments, device-side firmware 400 of remote control 200 is updated by central controller system 101 via a wireless interface.

Some embodiments provide one or more games and/or demo applications that demonstrate how to use the remote control (e.g., movement, controlling objects in the user interface, gestures, etc.).

### Calculating Attitude During Dynamic Acceleration

FIG. 11 is a diagram 500 illustrating exemplary gravity (G) and magnetic field (B) vectors that can be used to determine attitude, according to some embodiments. In some embodiments, G and B correspond to the Earth's gravity and the Earth's magnetic field, respectively. The Earth's magnetic field and gravity are assumed to form two stationary vectors. Using a magnetometer and an accelerometer, B and G may be measured. For example, the magnetic field vector B 501 and acceleration vector G 502 may be measured. When the remote control 200 is rotated, and then held stationary, B and G are measured again. In particular, the magnetic field vector B 503 and the acceleration vector G 504 may be measured. Given an unchanging relationship between B and G, the rotational operation that rotates B 501 and G 502 to B 503 and G 504, respectively, can be calculated. This rotation operation is the relative attitude/heading change.

Before continuing with the discussion, it is instructive to define two terms: body frame and the Earth frame. The body frame is the coordinate system in which B and G are measured with respect to a fixed point on the remote control 200. The diagram 500 in FIG. 11 illustrates the effect of a rotation of the remote control 200 as observed from the body frame. As the remote control 200 is held with one end or point of the remote control 200 at a fixed position, rotation of the remote control 200 causes B and G to move with respect to the body frame.

The Earth frame is the coordinate system in which B and G are measured with respect to a fixed point on the surface of the Earth. The Earth frame is typically the frame of reference for the user 103 of the remote control 200. When the user 103 moves the remote control 200, the user 103 typically thinks about the motion relative to the Earth frame.

Thus, the solution to the attitude of the remote control 200 can be formulated as follows: given two measurements of two constant vectors taken with respect to a body frame (of the remote control 200) that has undergone a rotation, solve for the rotation of the remote control 200 in the Earth frame.

There are a number of techniques can determine the attitude of the remote control 200. As discussed above, TRIAD is one such technique. Note that the following calculations may be formulated using Quaternion-based arithmetic to avoid issues with singularity associated with the TRIAD technique. The TRIAD technique operates as follows.

Given w₁ and w₂, which represent measurements (observations) of the B and G vectors in the body frame, the following are defined:

$$\begin{matrix}{r}_{1} = \frac{{w}_{1}}{\vert {w}_{1} \vert} & ( 1 ) \\ {r}_{2} = \frac{{r}_{1} \times {w}_{2}}{\vert {r}_{1} \times {w}_{2} \vert} & ( 2 ) \\ {r}_{3} = {r}_{1} \times {r}_{2} & ( 3 )\end{matrix}$$

where, r₁ is the normalized column vector w₁, r₂ is a normalized column vector orthogonal to r₁ and w₂, and r₃ is a normalized column vector orthogonal to r₁ and r₂.

Correspondingly, B and G are also known in the Earth frame. However these measurements are known a-priori; that is, they do not need to be measured and may be calculated from well-known theoretical models of the earth. For example, the magnitude and direction of the earth's magnetic and gravitational fields in San Jose, Calif. can be calculated without making new measurements. Thus the measurements in the body frame may be compared relative to these known vectors. If we call the vectors representing B and G in the Earth frame v₁ and v₂, then we may define:

$$\begin{matrix}{s}_{1} = \frac{{v}_{1}}{\vert {v}_{1} \vert} & ( 4 ) \\ {s}_{2} = \frac{{s}_{1} \times {v}_{2}}{\vert {s}_{1} \times {v}_{2} \vert} & ( 5 ) \\ {s}_{3} = {s}_{1} \times {s}_{2} & ( 6 )\end{matrix}$$

where s₁ is the normalized column vector v₁, s₂ is a normalized column vector orthogonal to s₁ and v₂, and s₃ is a normalized column vector orthogonal to s₁ and s₂.

Using the normalized column vectors defined above, the attitude matrix (A) that gives the rotational transform (e.g., for generating an uncorrected attitude of the remote control 200) in the Earth frame is:

A=R·S^{T} (7)

where R=[r₁|r₂|r₃] (e.g., a matrix comprised of the three column vectors r₁, r₂, and r₃), S=[s₁|s₂|s₃] (e.g., a matrix comprised of the three column vectors s₁, s₂, and s₃), and the “T” superscript denotes the transpose of the matrix to which it is applied.

Applying to the problem at hand, if v₁ and v₂ are given as the B and G vectors in the Earth frame and w₁ and w₂ are inferred from measurements produced by the multi-dimensional accelerometers 201-202 and the multi-dimensional magnetometer 203, the TRIAD technique may be used to compute the uncorrected attitude A of the remote control 200.

As discussed above, the accuracy of the relative heading/attitude of the remote control 200 determined by the TRIAD technique is predicated on the assumption that the device is not subject to dynamic acceleration. This assumption does not hold true in applications, in which the user 103 makes continuous movements and/or gestures with the remote control 200. FIG. 12 is a diagram 600 illustrating an attitude determination error caused at least in part by dynamic acceleration. At t=0, an acceleration measurement A_{OBS} 602 (i.e., Earth's gravity G) and a magnetic field measurement B 601 are measured. As the remote control 200 is rotated at t=1, an acceleration A_{DYN} 606 is induced on the remote control 200 so that the vector combination of Earth's gravity G 605 and A_{DYN} 606 produce an acceleration measurement A_{OBS} 604 in the body frame. Thus, the acceleration measurement A_{OBS} 604 does not measure G 605. Instead, it includes the error induced by A_{DYN} 606. Note that a magnetic field measurement B 603 is also measured in the body frame at t=1. Accordingly, an attitude calculation using Aₘₛ 604 and B 603 would include error due to the dynamic acceleration. Thus, the TRIAD technique introduces an error to the computed attitude proportionate to the size of A_{DYN} 606.

In order to solve the aforementioned problems, some embodiments include two or more accelerometers to measure the dynamic acceleration that the remote control 200 experiences. FIG. 13 is a diagram 700 illustrating an exemplary technique for compensating for dynamic acceleration in attitude calculations of a remote control 200, according to some embodiments. The remote control 200 includes multi-dimensional accelerometers 703 (A) and 704 (B) separated by a distance D 710. Furthermore, the distance from a pivot origin 702 to the multi-dimensional accelerometer 703 (A) is equal to rᵣₒₜ 720. The pivot origin 702 may be offset from the axis formed by the multi-dimensional accelerometers 703 (A) and 704 (B) by a distance L 722. For example, the distance L 722 may represent the offset between the axis of the multi-dimensional accelerometers 703 (A) and 704 (B) and a wrist of the user 103 as the remote control 200 is held in the hand of the user 103.

Dynamic acceleration experienced the remote control 200 may include translational acceleration imparted by lateral movement of the remote control 200 and rotational acceleration. When the remote control 200 is affected by translational acceleration, both multi-dimensional accelerometers 703-704 experience the same dynamic acceleration. When the device is affected by angular acceleration, the multi-dimensional accelerometers 703-704 experience dynamic acceleration proportional to their distance from the pivot origin 702.

For example, consider the case when the remote control 200 is pivoted about the pivot origin 702, causing the multi-dimensional accelerometers 703 and 704 to produce composite acceleration measurements A_{OBS} 705 and A_{OBS} 706. The composite acceleration measurement A_{OBS} 705 is a vector sum of the acceleration caused by Earth's gravity (G 707) and the dynamic acceleration a experienced by the first multi-dimensional accelerometer 703 (A). The composite acceleration measurement A_{OBS} 706 is a vector sum of the acceleration caused by Earth's gravity (G 707) and the dynamic acceleration b experienced by the second multi-dimensional accelerometer 704 (B). Note that since the multi-dimensional accelerometer 704 is farther from the pivot origin 702 than the multi-dimensional accelerometer 703, the acceleration due to the rotation about the pivot origin 702 is greater at the second multi-dimensional accelerometer 704 (B) than at the first multi-dimensional accelerometer 703 (A). A_{OBS} 705 and A_{OBS} 706 include errors 708 and 709, respectively.

The change in the attitude of the remote control 200 may be computed using measurements from both of the two multi-dimensional accelerometers 703-704. When the dynamic acceleration is entirely translational, the difference between the two computed attitudes is zero. In some embodiments, only rotational movement is translated into cursor movements. Thus, translational displacements do not result in translational cursor movement because purely translational movements do not affect yaw, pitch or roll. However, when the dynamic acceleration includes rotational components, the difference between the two accelerometer measurements produced by the two multi-dimensional accelerometers 703-704 is used to substantially reduce the error in the calculated attitude of the remote control 200 that is caused by dynamic acceleration, thereby creating a more accurate and efficient remote control.

### Determining Attitude Using a Kalman Filter

In some embodiments, the attitude of a remote control (e.g., the remote control 200 in FIG. 8, etc.) is determined by using a Kalman filter. Specifically, the Kalman filter may be an extended Kalman filter. Note that this specification uses the term “Kalman filter” to refer to an “extended Kalman filter”.

Attention is now directed to FIG. 14, which is a block diagram illustrating an exemplary method 800 for determining an attitude of a device undergoing dynamic acceleration, according to some embodiments. The Kalman filter generally includes two phases: a “predict” phase and an “update” phase. In the predict phase (802), an estimated state of the Kalman filter (which can also be considered to be a state of the device) from the previous timestep is used to produce a predicted estimate of the state (e.g., a “predicted state”) at a current timestep. Timesteps are sometimes called update periods or sampling periods. It should be understood that the epochs described in greater detail above in the discussion of user interface state error compensation typically include one or more of these timesteps (e.g., an error compensation epoch is an integer multiple of the timesteps). In the update phase (806), measurements (e.g., the acceleration measurements 204-205, the magnetic field measurement 206, etc.) sampled (804) from the sensors of the remote control (e.g., the multi-dimensional accelerometers 201-202, the multi-dimensional magnetometer 203, etc.) are used to correct the predicted state at the current timestep to produce an “updated state” (e.g., the estimated state that is used in the next time step). A mapping (808) is applied to the body rotation rate ω (e.g., obtained from the state vector of the Kalman filter) to convert (810) ω into the cursor motion. After determining the attitude of the remote control, the method then returns to the “predict phase” (802) at the next timestep. In some embodiments, the repeat rate of the method ranges from as slow as twenty times per second to as high as about 200 times per second, corresponding to timesteps ranging from as large as 50 milliseconds to as small as about 5 millisecond.

In some embodiments, during the predict phase, a predicted state \hat{x} and a predicted error covariance matrix P are determined as follows:

$$\begin{matrix}\hat{x} ( {t}_{k + 1} ) = {\int }_{{t}_{k}}^{{t}_{k + 1}} f ( x , u , t ) d t & ( 8 ) \\ {P}_{k} ( {t}_{k + 1} ) = Φ [ {P}_{k} ( {t}_{k} ) + Q ( {t}_{k} ) ] {Φ}^{- 1} & ( 9 )\end{matrix}$$

where \hat{x}(tₖ₊₁) is the predicted state of the Kalman filter at timestep k+1, f(x,u,t) are the dynamics of the system (defined below), x is the state, u is a control input (e.g., accelerations due to the arm of the user 103), t is time, Pₖ(tₖ) is the predicted error covariance matrix at timestep k, Pₖ(tₖ₊₁) is the predicted error covariance matrix at timestep k+1, Q(tₖ) is an approximation of the process noise matrix at timestep k, and Φ is a state transition matrix, which is obtained from the system dynamics.

The state transition matrix, Φ, is nominally an identity matrix (i.e., ones on the diagonal) for those states that do not have a dynamics model. A dynamics model is a model of the underlying dynamic system. For example, the dynamics model for a body in motion may include Newton's equations of motion. In some embodiments, the dynamics model for attitude determination is defined by Equations (15)-(21) below. In some embodiments, only the quaternion representing the attitude of the remote control and the vector including values representing the body rotation rate are associated with dynamic models. Thus, the only non-zero off-diagonal elements of the state transition matrix Φ are the portions of the state transition matrix that correspond to the covariances of the quaternion and body rotation rate states. Numerical values for this portion of the state transition matrix may be calculated for each timestep using a finite difference scheme instead of calculation of the dynamic system's Jacobian matrix. (Note that finding and integrating the Jacobian is the traditional technique of computing the state transition matrix.) In this finite difference scheme, a set of perturbed state vectors at time tₖ, as well as the unperturbed state, are propagated through the dynamics model (e.g., represented by equations (15)-(21) below). Each perturbed state vector is perturbed in a single state. The differences between the propagated perturbed state and the propagated unperturbed state are calculated. The difference vectors are divided by size of the initial perturbation. These difference vectors make up the dynamic portion of the state transition matrix.

In some embodiments, the process noise matrix, Q, only includes values on the diagonal elements of the matrix.

In some embodiments, the state of the Kalman filter includes a state vector defined as follows:

$$\hat{x} = [ \begin{matrix}{q}^{->} \\ {ω}^{->} \\ {r}_{rot} \\ {a}_{Yd} \\ {a}_{Zd}\end{matrix} ] \qquad ( 10 )$$

where \vec{q} is a vector including values of a quaternion representing the attitude of the remote control, \vec{ω} is a vector including values representing the body rotation rate (e.g., the rate at which the attitude of the remote control is rotating), rᵣₒₜ is a vector including a value that represents the radius of rotation between one of the multi-dimensional accelerometers (e.g., the multi-dimensional accelerometer 703 (A)) and the pivot origin (e.g., the pivot origin 702), a_{Yd} and a_{Zd} are the bias values in the Y and Z directions of the difference between the two accelerometer measurements (e.g., the accelerometer measurements 204-205). In some embodiments, the bias of the multi-dimensional magnetometer is estimated using a separate Kalman filter.

Before continuing with the discussion of the Kalman filter, it is instructive to discuss the quaternion \vec{q} representing the attitude of the remote control. FIG. 15 is a graph illustrating an exemplary quaternion 900, according to some embodiments. Any rotation (e.g., from one frame of reference to another, or from one attitude of a device to another) may be represented by a three-dimensional unit vector \hat{n} having components nₓ, n_{y}, and n₂, and an angle θ, which is the rotation about the unit vector \hat{n}. The rotation may be expressed as a normalized four-dimensional quaternion \vec{q} having the components q₁, q₂, q₃, and q₄ as follows:

$$\begin{matrix}{q}_{1} = {n}_{x} sin \frac{θ}{2} & ( 11 ) \\ {q}_{2} = {n}_{y} sin \frac{θ}{2} & ( 12 ) \\ {q}_{3} = {n}_{z} sin \frac{θ}{2} & ( 13 ) \\ {q}_{4} = cos \frac{θ}{2} & ( 14 )\end{matrix}$$

Returning to the discussion of the Kalman filter, in some embodiments, the function f(x,u,t) represents the equations of motion. For example, the equations of motion may be:

$$\begin{matrix}{q}^{\dot{->}} = [ \tilde{ω} ] {q}^{->} & ( 15 ) \\ {ω}^{\dot{->}} = h ( {{a}^{->}}_{diff} , {ω}^{->} ) & ( 16 ) \\ [ \tilde{ω} ] = \frac{1}{2} [ \begin{matrix}0 & - {ω}_{x} & - {ω}_{y} & - {ω}_{z} \\ {ω}_{x} & 0 & {ω}_{z} & - {ω}_{y} \\ {ω}_{y} & - {ω}_{z} & 0 & {ω}_{x} \\ {ω}_{z} & {ω}_{y} & {ω}_{x} & 0\end{matrix} ] & ( 17 )\end{matrix}$$

where {dot over (\vec{q} is the first time derivative of the quaternion \vec{q} representing the attitude of the remote control, \tilde{ω} (e.g., see Equation (17), where the components ωₓ, ω_{y}, and ω_{z} are the x, y, and z components of \vec{ω}) is the linear mapping of the body rates that when multiplied by quaternion state yields the time rate of change of the quaternion state, {dot over (\vec{ω} is the angular acceleration (e.g., first time derivative of the body rotation rate) of the remote control, h(\vec{a}_{diff},\vec{ω}) is a function of the vector representing the difference between the two accelerometer measurements (\vec{a}_{diff}) and the body rotation rate vector (\vec{ω}). h(\vec{a}_{diff},\vec{ω}) is defined below.

Each multi-dimensional accelerometer measures a composite (e.g., vector sum) of the following accelerations/forces: tangential, centripetal, gravitational (as measured in the body frame of the accelerometer), and translational. These acceleration components may be represented as follows:

\vec{a}_{A}=−{dot over (\vec{ω}×\vec{r}_{A}−\vec{ω}×\vec{ω}×\vec{r}_{A}+DCM(\vec{q})\vec{g}+\vec{a}ₜᵣₐₙₛₗₐₜᵢₒₙₐₗ (18)

\vec{a}_{B}=−{dot over (\vec{ω}×\vec{r}_{B}−\vec{ω}×\vec{ω}×\vec{r}_{B}+DCM(\vec{q})\vec{g}+\vec{a}ₜᵣₐₙₛₗₐₜᵢₒₙₐₗ (19)

where \vec{a}_{A} and \vec{a}_{B} are the composite accelerations measurements (e.g., the acceleration measurements 204-205) for each of the two accelerometers (e.g., the multi-dimensional accelerometers 201-202) of the remote control, {dot over (\vec{ω} is the rate of change of the body rotation rate \vec{ω}, \vec{r}_{A} and \vec{r}_{B} are the radius of rotations of each of the two accelerometers relative to a pivot origin, DCM(\vec{q}) is the direction cosine matrix (DCM) that is obtained from the quaternion \vec{q} representing the attitude of the remote control (e.g., the \vec{q} is converted to a DCM so that it can operate on the gravity vector \vec{g}), \vec{g} is the acceleration due to gravity as viewed from the body frame (e.g., the frame of the accelerometer), and \vec{a}ₜᵣₐₙₛₗₐₜᵢₒₙₐₗ is the translational acceleration.

Note that the Kalman state described above only includes a state value representing the radius of rotation, rᵣₒₜ, to one of the accelerometers (e.g., the multi-dimensional accelerometer 703 (A)). If the offset (e.g., L 722, FIG. 13 between the pivot origin (e.g., the pivot origin 702) and the axis of the accelerometers (e.g., the multi-dimensional accelerometers 703-704) are collinear (e.g., L 722 is zero), the magnitude of \vec{r}_{B} is rᵣₒₜ (e.g., rᵣₒₜ 720) plus the distance between the accelerometers (e.g., D 710, which is a known quantity). If the offset between the pivot origin and the axis of the accelerometers is non-zero, \vec{r}_{B} may be calculated from the geometric relationship between, \vec{r}_{A}, D 710, rᵣₒₜ, and the offset (e.g., by using the Pythagorean Theorem, etc.), where rᵣₒₜ and the offset are states of the Kalman filter.

A vector difference \vec{a}_{diff} between \vec{a}_{A} and \vec{a}_{B} yields:

\vec{a}_{diff}=\vec{a}_{B}−\vec{a}_{A}=−{dot over (\vec{ω}×\vec{r}_{diff}−\vec{ω}×\vec{ω}×\vec{r}_{diff} (20)

where, \vec{r}_{diff} is the vector difference between \vec{r}_{A} and \vec{r}_{B} (e.g., \vec{r}_{diff}=\vec{r}_{B}−\vec{r}_{A}). Note that \vec{a}_{diff} does not include the acceleration forces due to gravity and translation.

Equation (20) may be rearranged to solve for the angular acceleration {dot over (\vec{ω}:

$${ω}^{\dot{->}} {\vert}_{{ω}^{\dot{->}} \cdot {{r}^{->}}_{diff} = 0} = \frac{1}{{\vert {{r}^{->}}_{diff} \vert}^{2}} [ {{a}^{->}}_{diff} + {ω}^{->} \times {ω}^{->} \times {{r}^{->}}_{diff} ] \times {{r}^{->}}_{diff} \qquad ( 21 )$$

where {dot over (\vec{ω} is evaluated at {dot over (\vec{ω}·\vec{r}_{diff}=0 (e.g., when the only non-zero components of the angular acceleration {dot over (\vec{ω}, are orthogonal to the vector \vec{r}_{diff}, which is defined in paragraph [00130]). Equation (21) is then used in Equation (16). Note that a_{diff} is a measurement (e.g., from the multi-dimensional accelerometers), w is obtained from state vector, and \vec{r}_{diff} is the vector difference between \vec{r}_{A} and \vec{r}_{B}, as explained above.

In some embodiments, the number of states in the error covariance matrix P is reduced by expressing the variation of the quaternion state as orthogonal modified Rodrigues parameters (MRPs), which have three (3) parameters as compared to four (4) parameters in a quaternion. The MRP and the quaternion contain the same rotation information, but the redundant parameter in the quaternion avoids singularities. In these embodiments, the update of the quaternion state is estimated as an MRP rotation, and then converted to a quaternion. The update of the quaternion state is applied multiplicatively and preserves the unit norm property of the quaternion.

During the update phase, the predicted state matrix and predicted error covariance matrix are updated based on the sensor measurement as follows:

\hat{x}ₖ₊₁(tₖ)=\hat{x}(tₖ₊₁)+Kₖ(\vec{y}ₘ−ŷ) (22)

Pₖ₊₁(tₖ)=(I−KₖGₖ)Pₖ(tₖ) (23)

where \hat{x}ₖ₊₁(tₖ) is the updated state vector at timestep k+1, \hat{x}(tₖ₊₁) is the predicted state vector at timestep k that was calculated in the predict phase, Kₖ is the Kalman gain, \vec{y}ₘ is the observed measurements (e.g., the sensor measurements), ŷ is the predicted sensor measurements (e.g., the predicted sensor measurements that are obtained from the predicted state vector and the sensor models described in equations (28) and (29) below), I is the identity matrix, and Gₖ is an observation transformation matrix that maps the deviations from the state vector to deviations from the observed measurements (e.g., the sensor measurements). Note that the term \vec{y}ₘ−ŷ is referred to as a residual.

Generally, ŷ is a function of the state vector, the first time derivative of the state vector, and time (e.g., û=g(\vec{x},{dot over (\vec{x},t)), and may be determined using the sensor models described below. The Kalman gain Kₖ may be determined using the following equations:

$$\begin{matrix}{K}_{k} = {P}_{k} {G}_{k}^{T} {S}^{- 1} & ( 24 ) \\ {S}_{k} = {G}_{k} {p}_{k} {G}_{k}^{T} + R & ( 25 ) \\ {G}_{k} = \frac{\partial \hat{y}}{\partial {x}^{->}} & ( 26 )\end{matrix}$$

where R is the measurement covariance matrix.

In some embodiments, \vec{y}ₘ includes the following components:

$${{y}^{->}}_{m} = [ \begin{matrix}{{H}^{->}}_{xy} \\ {{a}^{->}}_{A} \\ {{a}^{->}}_{B}\end{matrix} ] \qquad ( 27 )$$

where \vec{H}_{xy} is the directional residual of the magnetic field measurement (e.g., the magnetic field measurement 206), \vec{a}_{A} is the accelerometer measurement (e.g., the accelerometer measurement 205) from a first multi-dimensional accelerometer (e.g., the multi-dimensional accelerometer 202), and \vec{a}_{B} is the accelerometer measurement (e.g., the accelerometer measurement 204) from a second multi-dimensional accelerometer (e.g., the multi-dimensional accelerometer 201). Note that the directional residual of the magnetic field measurement, \vec{H}_{xy}, may be used because when determining the attitude of a remote control, only the directional information is required; the magnitude of the magnetic field is not used. In fact, in these embodiments, attempting to correct/update the magnitude of the magnetic field in the Kalman filter state causes the Kalman filter state to diverge. \vec{H}_{xy} may be calculated from the magnetic field measurement using the technique described in “Spinning Spacecraft Attitude Estimation Using Markley Variables: Filter Implementation and Results” (Joseph E. Sedlak, 2005, available at http://www.ai-solutions.com/library/tech.asp), which is hereby incorporated by reference in its entirety.

In some embodiments, the sensor model for the multi-dimensional magnetometer and the multi-dimensional accelerometers are:

Ĥ_{xy}=[R_{Bzenith}][DCM(\hat{q}(tₖ₊₁))]\vec{H}_{ref} (28)

â=−{dot over (\vec{ω}×\vec{r}_{Acc}−\hat{ω}(tₖ₊₁)×\hat{ω}(tₖ₊₁)×\vec{r}_{Acc}+DCM(\vec{q}(tₖ₊₁))\vec{g} (29)

where Ĥ_{xy} is the two-dimensional directional residual between the measured and estimated magnetometer values, R_{Bzenith} is a rotation matrix that rotates the magnetic field measurement to the Z-axis vector in the new frame of reference (e.g., the frame of reference described in “Spinning Spacecraft Attitude Estimation Using Markley Variables: Filter Implementation and Results,” whereby the directional variances of a three dimensional vector are expressed as two variables), DCM(\hat{q}(tₖ₊₁)) is the DCM that is obtained from the quaternion \hat{q} representing the estimated attitude of the remote control (e.g., the \hat{q} is converted to a DCM so that it can operate on the gravity vector \vec{g} and/or \vec{H}_{ref}), \vec{H}_{ref} is the assumed magnetic field measurement in the Earth frame, and \vec{r}_{Acc} is the radius of rotation for a respective accelerometer, relative to the pivot point. The angular acceleration {dot over (\vec{ω} may be obtained from the difference of the accelerometer measurements (e.g., Equation (21)) and acts as a “pass-through” variable for the sensor measurements

In some embodiments, the state vector \hat{x} is a 10×1 matrix, the error covariance matrix P is a 9×9 matrix, and the observation partial derivative matrix G is an 8×9 matrix. In these embodiments, \vec{q} is a 4×1 vector, \vec{ω} a 3×1 vector, rᵣₒₜ is a 1×1 vector, and a_{Yd} and a_{Zd} are each 1×1 vectors. These components of the state vector \hat{x} together form a 10×1 matrix.

Accelerometer quantization may cause the attitude determined by the Kalman filter to incorrectly indicate that the remote control is moving when it is not. If left uncorrected, accelerometer quantization may significantly degrade performance of the system in which the remote control is used (e.g., the cursor on the central controller system may drift across the user interface). Thus, in some embodiments, for small values of the accelerometer measurements (e.g., values below twenty times the quantization interval), the techniques described in “Covariance Profiling for an Adaptive Kalman Filter to Suppress Sensor Quantization Effects” by D. Luong-Van et al. (43rd IEEE Conference on Decision and Control, Volume 3, pp. 2680-2685, 14-17 Dec. 2004), which is hereby incorporated by reference in its entirety, are used to mitigate the effects of the quantized data measurements reported by the accelerometers.

Furthermore, accelerometer noise may cause jitter causing the attitude determined by the Kalman filter to indicate that the remote control is moving even when the remote control at rest. Thus, in some embodiments, a deadband is used for values of the accelerometer measurements that occur in a specified range of quantization levels of the accelerometer measurements. For example, the specified range may be between two and twenty times the quantization level of the accelerometers. Note that it is desirable to minimize the deadband, but this minimization must be balanced against the device performance at low angular rates and accelerations where quantization effects will dominate the behavior of the pointer.

### Adaptive Kalman Gain

As discussed above, substantial error can arise in the calculation of the attitude of a remote control that is undergoing dynamic acceleration. These errors arise from the inability of a single multi-dimensional accelerometer to distinguish between the effects of dynamic acceleration and the actual gravity vector. To compensate for this, in some embodiments, the acceleration measurements from the accelerometers are given less weight when the remote control is undergoing dynamic acceleration than when the remote control is not undergoing dynamic acceleration.

The weight of the acceleration measurements in the Kalman filter may be controlled by the Kalman gain (Kₖ). Thus, in some embodiments, the Kalman gain is adjusted based on the amount of dynamic acceleration experienced by the remote control. For example, the Kalman gain may be adjusted through the measurement covariance matrix R (see equations 24 and 25, above).

Attention is now directed to FIG. 16, which is a flow diagram of a method 1000 for determining an attitude of a device undergoing dynamic acceleration, according to some embodiments. A difference between a first accelerometer measurement received from a first multi-dimensional accelerometer of the device and a second accelerometer measurement received from a second multi-dimensional accelerometer of the device is calculated (1002) (e.g., see Equation (20)).

A Kalman gain based on the difference is adjusted (1004), wherein the Kalman gain is used in a Kalman filter that determines the attitude of the device. When the difference is less than a specified threshold, values associated with the first accelerometer measurement and the second accelerometer measurement in a measurement covariance matrix of the Kalman filter (e.g., R) are decreased so that the first accelerometer measurement and the second accelerometer measurement are given more weight in the Kalman filter relative to the magnetic field measurement than when the difference is greater than the specified threshold. When the difference is greater than a specified threshold, covariance values associated with the first accelerometer measurement and the second accelerometer measurement in a measurement covariance matrix of the Kalman filter (e.g., R) are increased so that the first accelerometer measurement and the second accelerometer measurement are given less weight in the Kalman filter relative to the magnetic field measurement than when the difference is less than the specified threshold. For example, when the difference is greater than the specified threshold, the covariance values associated with the first accelerometer measurement and the second accelerometer measurement may be increased by a factor of 100 compared with their values when the difference is less than the specified threshold. This threshold may be defined as being the same differential acceleration threshold as defined for the deadband.

An attitude of the device is determined (1006) using the Kalman filter based at least in part on the Kalman gain, the first accelerometer measurement, the second accelerometer measurement, and a magnetic field measurement received from a multi-dimensional magnetometer of the device. For example, the Kalman filter described above with reference to FIG. 14 and Equations (8)-(29) may be used to determine the attitude of the device.

What is claimed is:

1. A method for remotely controlling devices, comprising:
at a computer system including one or more processors and memory storing one or more programs, the one or more processors executing the one or more programs to perform the operations of:
receiving data corresponding to a device-selection command performed at a remote control, wherein the remote control is configured to provide remote-control commands to a plurality of devices; and
in response to receiving the data corresponding to the device-selection command:
selecting one of the devices as a selected device in accordance with information indicating that the remote control was pointed at a proxy for the selected device at the time that the device-selection command was performed at the remote control, wherein the proxy for the selected device is at a different location than the selected device; and
generating a respective remote-control command for the selected device, wherein the respective remote-control command will, when received by the selected device, cause the selected device to perform a predefined operation that corresponds to the respective remote-control command.

2. The method of claim 1, wherein the computer system is the remote control.

3. The method of claim 1, wherein the computer system is a controller that is in communication with the plurality of devices.

4. The method of claim 1, wherein the remote control is a multifunction device with a remote control application.

5. The method of claim 1, wherein the remote control is a dedicated remote control device.

6. The method of claim 1, further including preparing, for display at the remote control, information identifying the selected device.

7. The method of claim 1, wherein the selecting includes:
identifying multiple candidate devices from the plurality of devices in accordance with the navigational state; and
selecting a respective candidate device from the multiple devices as the selected device.

8. The method of claim 7, wherein, the multiple candidate devices are identified in accordance with historical navigational states of the remote control.

9. The method of claim 7, wherein, the respective candidate device is selected in accordance with additional input from a user of the remote control.

10. The method of claim 7, further comprising, prior to selecting the respective candidate device:
generating a list including two or more of the multiple candidate devices; and
receiving a response indicating selection of the respective candidate device from the list.

11. The method of claim 7, wherein, the respective candidate device is automatically selected using predefined criteria.

12. The method of claim 1, wherein:
receiving the data corresponding to a device-selection command includes receiving data corresponding to a plurality of device-selection commands for a single device, where the plurality of device-selection commands were performed at a plurality of distinct remote controls; and
the remote-control command is generated in accordance with predefined criteria.

13. The method of claim 1, wherein:
the selected device has a predefined device class;
the respective remote-control command is a broadcast command that is broadcast to two or more of the plurality of devices; and
the respective remote-control command will, when received by a respective additional device that has the predefined device class, cause the respective additional device to perform the predefined operation.

14. The method of claim 1, wherein the selected device has a predefined device class, and the method further comprises, after selecting the selected device:
identifying one or more additional devices that have the predefined device class; and
generating one or more additional remote-control commands, wherein a respective additional remote-control command will, when received by a respective additional device, cause the respective additional device to perform the predefined operation.

15. The method of claim 1, further comprising:
acquiring one or more sensor inputs that correspond to beacon data for one or more beacons on the remote control; and
calculating the navigational state of the remote control, in accordance with the acquired sensor inputs, as the remote control is moved by a user.

16. The method of claim 1, further comprising:
acquiring one or more sensor inputs from sensors on the remote control; and
calculating the navigational state of the remote control, in accordance with the acquired sensor inputs, as the remote control is moved by a user.

17. The method of claim 1, wherein the remote control includes:
one or more absolute sensors; and
one or more relative sensors.

18. The method of claim 17, wherein the at least one absolute sensor is selected from the group consisting of:
a multi-dimensional magnetometer and a multi-dimensional accelerometer;
one or more magnetic beacon sensors;
one or more sonic beacon sensors; and
one or more radio-frequency beacon sensors.

19. The method of claim 17, wherein the at least one relative sensor is selected from the group consisting of:
an inertial measurement unit;
one or more gyroscopes; and
one or more accelerometers.

20. A computer system, comprising:
one or more processors;
memory; and
one or more programs, wherein the one or more programs are stored in the memory and configured to be executed by the one or more processors, the one or more programs including instructions for:
receiving data corresponding to a device-selection command performed at a remote control, wherein the remote control is configured to provide remote-control commands to a plurality of devices; and
in response to receiving the data corresponding to the device-selection command:
selecting one of the devices as a selected device in accordance with information indicating that the remote control was pointed at a proxy for the selected device at the time that the device-selection command was performed at the remote control, wherein the proxy for the selected device is at a different location than the selected device; and
generating a respective remote-control command for the selected device, wherein the respective remote-control command will, when received by the selected device, cause the selected device to perform a predefined operation that corresponds to the respective remote-control command.

21. A non-transitory computer readable storage medium storing one or more programs, the one or more programs comprising instructions, which when executed by a computer system with one or more processors, cause the computer system to:
receive data corresponding to a device-selection command performed at a remote control, wherein the remote control is configured to provide remote-control commands to a plurality of devices; and
in response to receiving the data corresponding to the device-selection command:
select one of the devices as a selected device in accordance with information indicating that the remote control was pointed at a proxy for the selected device at the time that the device-selection command was performed at the remote control, wherein the proxy for the selected device is at a different location than the selected device; and
generate a respective remote-control command for the selected device, wherein the respective remote-control command will, when received by the selected device, cause the selected device to perform a predefined operation that corresponds to the respective remote-control command.

22. A method for remotely controlling devices, comprising:
at a computer system including one or more processors and memory storing one or more programs, the one or more processors executing the one or more programs to perform the operations of:
receiving data corresponding to a device-selection command performed at a remote control, wherein the remote control is configured to provide remote-control commands to a plurality of devices; and
in response to receiving the data corresponding to the device-selection command:
selecting a first device in accordance with information indicating that the remote control was pointed at the first device at the time that the device-selection command was performed at the remote control, wherein the selected device is a member of a predefined device class; and
generating a respective remote-control command for a set of devices that are members of the predefined device class including the first device and a second device different from the first device, wherein the respective remote-control command will, when received by the first device and the second device, cause the first device and the second device to perform a same predefined operation that corresponds to the respective remote-control command.
